(19) United States
(12) Patent Application Publication
(10) Pub. No.: US 2025/0259367 A1
(43) Pub. Date: Aug. 14, 2025

(54) VIRTUAL DIGITAL HUMAN GENERATION METHOD AND APPARATUS, AND ELECTRONIC DEVICE

(71) Applicant: HISENSE VISUAL TECHNOLOGY CO., LTD., Qingdao (CN)

(72) Inventors: Zhaolei LIU, Qingdao (CN); Luming YANG, Qingdao (CN); Naijin LI, Qingdao (CN); Zhikui WANG, Qingdao (CN); Yang SHEN, Qingdao (CN); Xusong LI, Qingdao (CN); Aiguo FU, Qingdao (CN); Shansong YANG, Qingdao (CN)

(21) Appl. No.: 19/194,839

(22) Filed: Apr. 30, 2025

Related U.S. Application Data
(63) Continuation of application No. PCT/CN2023/112848, filed on Aug. 14, 2023.

(30) Foreign Application Priority Data
Dec. 12, 2022 (CN) 202211597595.4
Dec. 30, 2022 (CN) 202211735800.9

(51) Int. Cl. G06T 13/40; G06T 7/60; G06T 7/73; G06T 11/00; G06T 11/20; G06T 13/80

(52) U.S. Cl. CPC G06T 13/40; G06T 7/60; G06T 7/73; G06T 11/001; G06T 11/203; G06T 13/80; G06T 2207/10016; G06T 2207/30201

(57) ABSTRACT

Provided are a virtual digital human generation method and apparatus, and an electronic device. The method includes: acquiring a first image frame collected by an image collection apparatus when a target video is played; performing human body key identification on the first image frame, to determine position information between human body key points, a first actual length of a target body part, and a second actual length of a body part other than the target body part; on the basis of a target proportional relationship and the first actual length, determining a predicted length of the body part other than the target body part; on the basis of the second actual length and the predicted length, determining a drawing height of the other body part; and performing drawing on the basis of the first actual length, the drawing height and position information, to generate a virtual digital human.

### CROSS REFERENCE TO RELATED APPLICATIONS

The application is a continuation of International Application No. PCT/CN2023/112848, filed on Aug. 14, 2023, which claims the priority to Chinese Patent Application No. 202211597595.4 filed on Dec. 12, 2022, and the priority to Chinese Patent Application No. 202211735800.9 filed on Dec. 30, 2022. All of the aforementioned patent applications are incorporated herein in their entireties by reference.

### TECHNICAL FIELD

The present application relates to the technical field of human-computer interaction, and in particular to a virtual digital human generation method and apparatus, and an electronic device.

### BACKGROUND

Currently, in a field of human-computer interaction technology, users can play fitness videos on electronic devices (such as smart televisions, mobile phones and the like) and do corresponding fitness movements to complete their workouts. However, when different users learn from the same fitness video, there are significant differences in the fitness movements they do, resulting in the poor fitness effect. Therefore, how to ensure the consistency of the fitness movements that users do according to the fitness videos played on electronic devices has become an urgent problem to be solved.

### SUMMARY

In a first aspect, the application provides a method for generating a virtual digital human, including: obtaining a first frame image collected by an image acquisition device when playing a target video; where the target video includes at least one fitness action; performing human key recognition on the first frame image, to determine position information between human key points, a first actual length of a target body part, and a second actual length of other body part except the target body part; determining a predicted length of the other body part except the target body part according to a target proportional relationship and the first actual length; where the target proportional relationship includes a corresponding ratio of the first actual length to the predicted length of the other body part except the target body part; determining a drawing height of the other body part based on the second actual length and the predicted length; and generating the virtual digital human by drawing based on the first actual length, the drawing height, and the position information.

In a second aspect, the application provides an apparatus for generating a virtual digital human, including: a display, configured to display an image and/or user interface; and at least one processor, configured to execute instructions to cause the apparatus to: obtain a first frame image collected by the image acquisition device when playing a target video; where the target video includes at least one fitness action; perform human key recognition on the first frame image, to determine position information between human key points, a first actual length of a target body part, and a second actual length of other body part except the target body part; determine a predicted length of the other body part except the target body part according to a target proportional relationship and the first actual length; where the target proportional relationship includes a corresponding ratio of the first actual length to the predicted length of the other body part except the target body part; determine a drawing height of the other body part based on the second actual length and the predicted length; and generate the virtual digital human by drawing based on the first actual length, the drawing height, and the position information.

In a third aspect, the application provides an electronic device, including: a memory and a processor. The memory is configured to store a computer program; and the processor is configured to execute the computer program to enable the electronic device to implement any method for generating the virtual digital human according to the first aspect described above.

In a fourth aspect, the application provides a computer non-volatile readable storage medium, where a computer program is stored on the computer non-volatile readable storage medium. When executed by a computing device, the computer program causes the computing device to implement any method for generating the virtual digital human according to the first aspect described above.

In a fifth aspect, the application provides a computer program product. When the computer program product runs on a computer, the computer program product enables the computer to execute any method for generating the virtual digital human according to the first aspect described above.

It should be noted that the above-mentioned computer instructions may be stored wholly or partly on a first computer non-volatile readable storage medium. Herein, the first computer non-volatile readable storage medium may be packaged together with the processor of the apparatus for generating a virtual digital human, or may be packaged separately from the processor of the apparatus for generating a virtual digital human, which is not limited in the application.

For the descriptions in the second aspect, the third aspect, the fourth aspect and the fifth aspect of the application, reference may be made to the detailed description of the first aspect. For beneficial effects of the descriptions in the second aspect, the third aspect, the fourth aspect and the fifth aspect, reference may be made to the analysis of the beneficial effect of the first aspect. Details will not be repeated here.

In the application, a name of the above-mentioned apparatus for generating a virtual digital human does not constitute any limitation to the device or functional module itself. In actual implementation, these devices or functional modules may be named differently, as long as the functions of each device or functional module are similar to those of the application and fall within the scope of claims of the application and their equivalent technologies.

### BRIEF DESCRIPTION OF FIGURES

The accompanying drawings herein are incorporated into the specification and constitute a part of the specification, illustrate the embodiments conforming to the application, and are used together with the description to explain the principle of the application.

In order to more clearly illustrate technical solutions in the embodiments of the application or in the prior art, the following will briefly introduce the accompanying drawings required in the description of the embodiments or the prior art. Obviously, for those of ordinary skill in the art, other accompanying drawings can also be obtained according to these accompanying drawings without creative efforts.

FIG. 1 is a schematic diagram of a scenario of a method for generating a virtual digital human according to some embodiments of the application.

FIG. 2 is a first schematic structural diagram of a display apparatus in the method for generating a virtual digital human according to some embodiments of the application.

FIG. 3 is a second schematic structural diagram of the display apparatus in the method for generating a virtual digital human according to some embodiments of the application.

FIG. 4 is a first schematic flowchart of the method for generating a virtual digital human according to some embodiments of the application.

FIG. 5 is a schematic diagram of human body key points in the method for generating a virtual digital human according to some embodiments of the application.

FIG. 6 is a schematic diagram of body parts in the method for generating a virtual digital human according to some embodiments of the application.

FIG. 7 is a second schematic flowchart of the method for generating a virtual digital human according to some embodiments of the application.

FIG. 8 is a third schematic flowchart of the method for generating a virtual digital human according to some embodiments of the application.

FIG. 9 is a fourth schematic flowchart of the method for generating a virtual digital human according to some embodiments of the application.

FIG. 10 is a fifth schematic flowchart of the method for generating a virtual digital human according to some embodiments of the application.

FIG. 11 is a sixth schematic flowchart of the method for generating a virtual digital human according to some embodiments of the application.

FIG. 12 is a seventh schematic flowchart of the method for generating a virtual digital human according to some embodiments of the application.

FIG. 13 is a schematic diagram of a target interface in the method for generating a virtual digital human according to some embodiments of the application.

FIG. 14 is a schematic diagram of a preset interface in the method for generating a virtual digital human according to some embodiments of the application.

FIG. 15 is a schematic structural diagram of the display apparatus according to some embodiments of the application.

FIG. 16 is a schematic diagram of a chip system according to some embodiments of the application.

FIG. 17 is a hardware configuration block diagram of an animation generation apparatus according to some embodiments of the application.

FIG. 18 is a schematic diagram of a network architecture of the animation generation apparatus according to some embodiments of the application.

FIG. 19 is a flowchart of steps of an animation generation method according to some embodiments of the application.

FIG. 20 is a schematic diagram of an animation generation method according to some embodiments of the application.

FIG. 21 is another schematic diagram of the animation generation method according to some embodiments of the application.

FIG. 22 is another flowchart of steps of the animation generation method according to some embodiments of the application.

FIG. 23 is a schematic diagram of the animation generation method according to some embodiments of the application.

FIG. 24 is another flowchart of steps of the animation generation method according to some embodiments of the application.

FIG. 25 is an architecture diagram of the animation generation method according to some embodiments of the application.

FIG. 26 is another architecture diagram of the animation generation method according to some embodiments of the application.

FIG. 27 is another overall framework diagram of the animation generation method according to some embodiments of the application.

### DETAILED DESCRIPTION

In order to more clearly understand the above objectives, features and advantages of the present application, solutions of the present application will be further described below. It should be noted that, in the case of no conflict, embodiments of the present application and features in the embodiments can be combined with each other.

Many specific details are set forth in the following description to provide a thorough understanding of the present application. However, the present application can also be implemented in other ways different from those described herein. Obviously, embodiments in the description are only a part of the embodiments of the present application, rather than all of them.

It should be noted that, in the application, relational terms such as “first” and “second” are merely used to distinguish one entity or operation from another entity or operation, and do not necessarily require or imply any actual relationship or sequence between these entities or operations. Moreover, terms “include”, “comprise” or any other variations thereof are intended to cover non-exclusive inclusions, such that a process, method, article, or device that includes a series of elements not only includes those elements but also includes other elements not explicitly listed, or also includes elements that are inherent to such a process, method, article or device. Without further limitations, an element defined by a statement “including one . . . ” does not exclude the presence of additional identical elements in the process, method, article or device that includes the element.

In the embodiments of the present application, Convolutional Pose Machine (CPM) is used to apply deep learning to human pose analysis and is the predecessor of the open-source project OpenPose of Carnegie Mellon University (CMU).

In the embodiments of the present application, OpenPose is an open-source library developed based on convolutional neural networks and supervised learning and using Caffe as a framework.

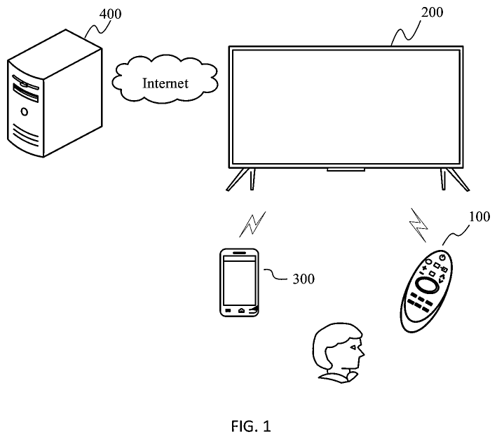

FIG. 1 is a schematic diagram of an operation scenario between a display apparatus and a control device according to one or more embodiments of the present application. As shown in FIG. 1, a user can operate the display apparatus 200 through a mobile terminal 300 and the control device 100. The control device 100 can be a remote controller, and the remote controller may communicate with the display apparatus to control the display apparatus 200 via infrared protocol communication, Bluetooth protocol communication, wireless or other wired methods. The user can input a user command through keys on the remote controller, voice input, control panel input and the like to control the display apparatus 200. In some embodiments, a mobile terminal, a tablet, a computer, a laptop, and other smart devices can also be used to control the display apparatus 200.

In some embodiments, software applications may be installed on a mobile terminal 300 and the display apparatus 200, to achieve connection and communication through network communication protocols, and achieve the purpose of one-to-one control operations and data communication. It is also possible to transmit the audio and video content displayed on the mobile terminal 300 to the display apparatus 200 to achieve the synchronous display function. The display apparatus 200 also performs data communication with a server 400 through various communication methods. The display apparatus 200 may be allowed to perform communication connection through a local area network (LAN), a wireless local area network (WLAN) and other networks. The server 400 can provide various contents and interactions to the display apparatus 200. The display apparatus 200 can be a liquid crystal display, an organic light-emitting diode (OLED) display, or a projection display apparatus. In addition to providing the function of receiving the broadcast television, the display apparatus 200 can also additionally provide a smart internet television function with computer support functions.

In some embodiments, an electronic device provided in the embodiments of the present application can be the above-mentioned display apparatus 200. When the users need to work out, they can turn on the display apparatus 200, and the display apparatus 200 runs a first application that can play a target video (such as a fitness video). The first application displays a start interface based on the start operation. After that, the user can select the target video to be played in the start interface. For example, if the user selects the target video, after receiving the user's selection operation on the target video and before starting to play the target video, the first application needs to prompt the user to face an image acquisition device and do a target action, such as a standing action. In this case, when the user faces the image acquisition device according to the prompt and does the standing action, the image acquisition device can capture a second frame image in which the user faces the image acquisition device and does the standing action. After that, the first application performs human key recognition on the second frame image to determine at least one human key point and configuration information of each human key point. Based on determining that both position information and a confidence level meet a standing condition, the first application obtains a control height of a preview control. After that, the first application determines a human height according to first information and second information. The first application determines a target proportional relationship according to the human height and the control height. During a process of playing the target video, when the users need to know whether the fitness action they are currently doing is consistent with the fitness action of the target video played by the first application, they can perform a selection operation on a target function. In this case, based on the selection operation on the target function, the first application obtains the first frame image collected by the image acquisition device when playing the target video, and performs human key recognition on the first frame image to determine position information between human key points, a first actual length of a target body part, and a second actual length of other body part except the target body part. After that, the first application determines a predicted length of the other body part except the target body part according to a pre-determined target proportional relationship and the first actual length. After that, the first application determines a drawing height of the other body part based on the second actual length and the predicted length. Finally, the first application generates a virtual digital human by drawing based on the first actual length, the drawing height, and the position information. After that, the first application displays the target interface. In this way, while watching the target video, the user can also view the virtual digital human. Since the fitness action corresponding to the virtual digital human is the same as the user's current fitness action, the users can intuitively know whether the fitness action they are currently doing is consistent with the fitness action of the target video played by the first application, which improves the user experience.

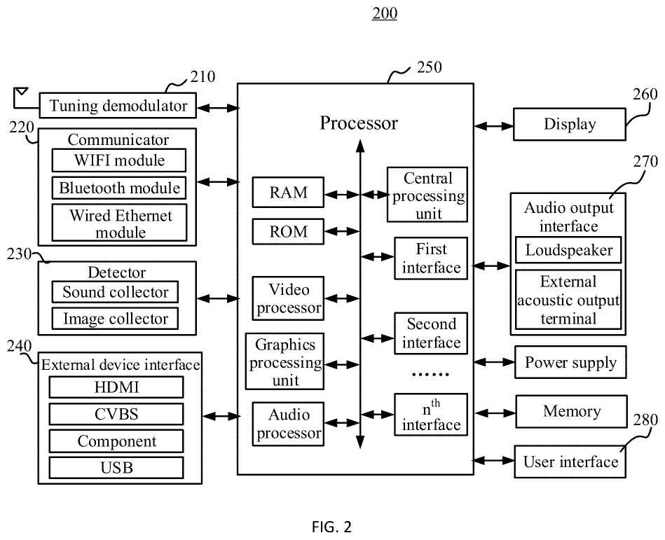

FIG. 2 shows a block diagram of hardware configuration of the display apparatus 200 according to an exemplary embodiment. As shown in FIG. 2, the display apparatus 200 includes at least one of a tuning demodulator 210, a communicator 220, a detector 230, an external device interface 240, a processor 250, a display 260, an audio output interface 270, a memory, a power supply, and a user interface 280. The processor(s) includes a central processing unit, a video processor, an audio processor, a graphics processing unit, a random-access memory (RAM), a read-only memory (ROM), and a first interface to an n^{th} interface for input/output. The display 260 can be a display with a touch function, such as a touch display. The tuning demodulator 210 receives a broadcast television signal in a wired or wireless reception mode, and demodulates audio and video signals, such as an electronic program guide (EPG) data signal, from a plurality of wireless or wired broadcast television signals. The detector 230 is configured to collect signals of an external environment or interaction with the outside. The processor 250 and the tuning demodulator 210 can be located in different split devices, that is, the tuning demodulator 210 can also be in an external device of a main device of the processor 250, such as an external set-top box.

In some embodiments, the image acquisition device can be a camera. The display apparatus 200 can be provided with at least one camera. The camera can be built into the display apparatus 200, or the camera is connected to the display apparatus 200 in a wired or wireless mode. For example, the camera can be disposed at a lower edge of the display 260 of the display apparatus 200. Of course, a position of the camera on the display apparatus 200 is not limited in the embodiments of the present application. Alternatively, the display apparatus 200 may not include a camera, that is, the camera is not disposed in the display apparatus 200. The display apparatus 200 can be externally connected to a camera through an interface (such as a universal serial bus (USB) interface 130). The externally connected camera can be fixed on the display apparatus 200 through an external fixing member (such as a camera bracket with a clip). For example, the externally connected camera can be fixed at an edge of the display 260 of the display apparatus 200, such as an upper edge, through an external fixing member.

In some embodiments, the processor 250 controls the working of the display apparatus and responds to the user's operation through various software control programs stored in the memory. The processor 250 controls the overall operation of the display apparatus 200.

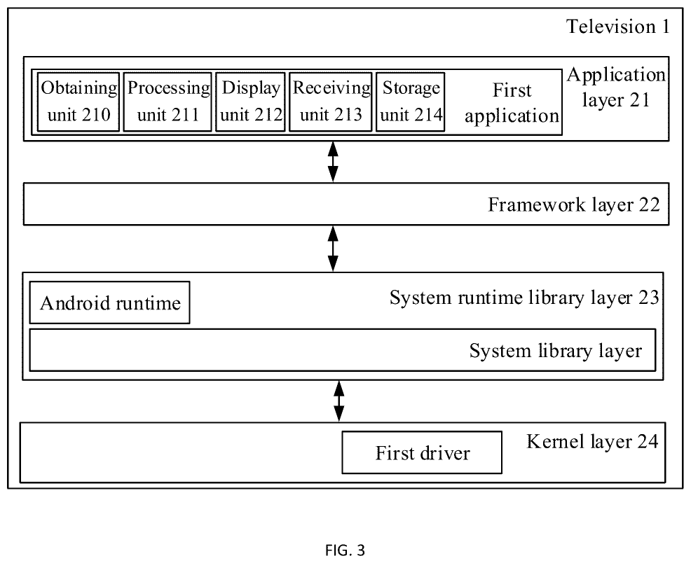

In some examples, taking the display apparatus 200 in one or more embodiments of the present application as a television 1, and an operating system of the television 1 as an Android system for an example, as shown in FIG. 3, the television 1 can be logically divided into an application (applications) layer 21, an application framework layer (referred to as a “framework layer” for short) 22, an Android runtime and system library layer (referred to as a “system runtime library layer” for short) 23, and a Kernel layer 24.

Herein, the application layer 21 includes one or more applications. The application can be a system application or a third-party application. For example, the application layer 21 includes a first application, and the first application can provide the function of playing fitness videos. The framework layer 22 provides an application programming interface (API) and a programming framework for the applications in the application layer 21. The system runtime library layer 23 provides support for an upper layer, that is, the framework layer 22. When the framework layer 22 is used, the Android operating system may run the C/C++ libraries included in the system runtime library layer 23 to implement the functions to be implemented by the framework layer 22. The kernel layer 24, as a software middleware between the hardware layer and the application layer 21, is used to manage and control hardware and software resources.

In some examples, the kernel layer 24 includes a first driver, and the first driver is configured to send user operations collected by the detector 230 to the first application. After an obtaining unit 210 of the first application receives the user operation sent by the first driver, a processing unit 211 analyzes the user operation obtained by the obtaining unit 210. For example, when the user operation is a start operation, based on the start operation, the processing unit 211 controls a display unit 212 to display the start interface. After that, the user can select the target video to be played in the start interface. For example, if the user performs a selection operation on the target video, after determining that a receiving unit 213 has received the user's selection operation on the target video, and before starting to play the target video, the processing unit 211 of the first application needs to prompt the user to face the image acquisition device and do a target action, such as a standing action. In this case, when the user faces the image acquisition device according to the prompt and does the standing action, the image acquisition device can capture a second frame image in which the user faces the image acquisition device and does the standing action. After that, the processing unit 211 of the first application performs human key recognition on the second frame image obtained by the obtaining unit 210 to determine at least one human key point and configuration information of each human key point. Based on determining that both the position information and the confidence level meet the standing condition, the processing unit 211 of the first application controls the obtaining unit 210 to obtain the control height of the preview control. After that, the processing unit 211 of the first application determines the human height according to the first information and the second information. The processing unit 211 of the first application determines the target proportional relationship according to the human height and the control height obtained by the obtaining unit 211. During the process of the display unit 212 playing the target video under the control of the processing unit 211 of the first application, when the users need to know whether the fitness action they are currently doing is consistent with the fitness action of the target video played by the first application, they can perform a selection operation on the target function. In this case, the detector 230 sends the collected selection operation on the target function to the first application. The obtaining unit 210 of the first application receives the selection operation on the target function sent by the detector 230. Based on the selection operation on the target function received by the obtaining unit 210, the processing unit 211 of the first application controls the obtaining unit 210 to obtain the first frame image collected by the image acquisition device when playing the target video. The processing unit 211 of the first application performs human key recognition on the first frame image obtained by the obtaining unit 210 to determine the position information between the human key points, the first actual length of the target body part, and the second actual length of other body part except the target body part. After that, the processing unit 211 of the first application determines the predicted length of the other body part except the target body part according to the pre-determined target proportional relationship and the first actual length. After that, the processing unit 211 of the first application determines the drawing height of the other body part based on the second actual length and the predicted length. Finally, the processing unit 211 of the first application generates a virtual digital human by drawing based on the first actual length, the drawing height and the position information. After that, the processing unit 211 of the first application controls the display unit 212 to display the target interface.

Specifically, the electronic device in the embodiments of the present application can be the above-mentioned display apparatus 200 or a server 400, which is not limited here.

Specifically, a storage unit 214 is configured to store application programs of the first application, the target proportional relationship, etc.

Both the first frame image and the second frame image involved in the present application can be data authorized by the user or fully authorized by all parties.

In the following embodiments, taking the display apparatus 200 as an executing entity of the method for generating a virtual digital human in the embodiments of the present application for an example, the method of the embodiments of the present application is described.

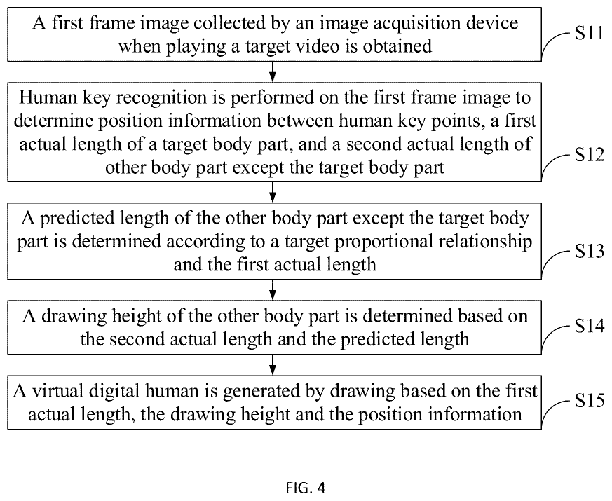

The embodiments of the present application provide a method for generating a virtual digital human. As shown in FIG. 4, the method for generating a virtual digital human can include S11-S15.

S11. A first frame image collected by an image acquisition device when playing a target video is obtained. Herein, the target video includes at least one fitness action.

In some examples, when the display apparatus 200 plays the target video, the user can do corresponding actions according to the played fitness actions to achieve the fitness effect. In order to ensure the consistency of the fitness actions done by the user and the fitness actions corresponding to the target video played by the display apparatus 200, the method for generating a virtual digital human in the embodiments of the present application obtains the first frame image collected by the image acquisition device when playing the target video, and then performs human key recognition on the first frame image to obtain the position information between the human key points, the first actual length of the target body part, and the second actual length of the other body part except the target body part. After that, according to the target proportional relationship and the first actual length, the predicted length of the other body part except the target body part is determined. Based on the second actual length and the predicted length, the drawing height of the other body part is determined. Finally, a virtual digital human is generated by drawing based on the first actual length, the drawing height, and the position information. When the user performs a selection operation on the target function, the display apparatus 200 can display the target interface, so that the user can view the virtual digital human while watching the target video. The virtual digital human is drawn according to the actual position information of the user's human key points, the first actual length and the second actual length, so that the fitness action corresponding to the virtual digital human is the same as the user's current fitness action. Therefore, the users can intuitively know whether the fitness action they are currently doing is consistent with the fitness action of the target video played by the first application, which improves the user experience.

S12. Human key recognition is performed on the first frame image to determine position information between human key points, a first actual length of a target body part, and a second actual length of other body part except the target body part.

In some examples, the human key points include one or more of the following: a human key point representing a skeletal joint as a nose, a human key point representing the skeletal joint as a left eye, a human key point representing the skeletal joint as a right eye, a human key point representing the skeletal joint as a left ear, a human key point representing the skeletal joint as a right ear, a human key point representing the skeletal joint as a left shoulder, a human key point representing the skeletal joint as a right shoulder, a human key point representing the skeletal joint as a left elbow, a human key point representing the skeletal joint as a right elbow, a human key point representing the skeletal joint as a left wrist, a human key point representing the skeletal joint as a right wrist, a human key point representing the skeletal joint as a left hip, a human key point representing the skeletal joint as a right hip, a human key point representing the skeletal joint as a left knee, a human key point representing the skeletal joint as a right knee, a human key point representing the skeletal joint as a left ankle, a human key point representing the skeletal joint as a right ankle, a human key point representing the skeletal joint as a left palm center, and a human key point representing the skeletal joint as a right palm center.

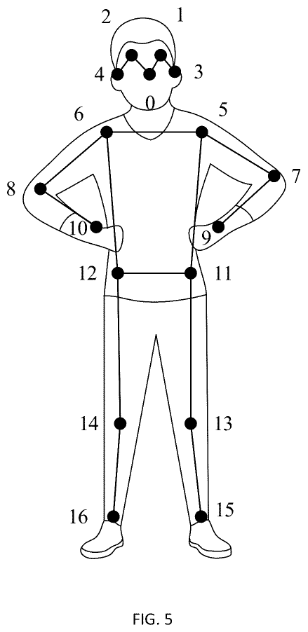

Exemplarily, the distribution of the human key points on the human body is shown in FIG. 5. Herein, 0 denotes the human key point representing the skeletal joint as the nose, 1 denotes the human key point representing the skeletal joint as the left eye, 2 denotes the human key point representing the skeletal joint as the right eye, 3 denotes the human key point representing the skeletal joint as the left ear, 4 denotes the human key point representing the skeletal joint as the right ear, 5 denotes the human key point representing the skeletal joint as the left shoulder, 6 denotes the human key point representing the skeletal joint as the right shoulder, 7 denotes the human key point representing the skeletal joint as the left elbow, 8 denotes the human key point representing the skeletal joint as the right elbow, 9 denotes the human key point representing the skeletal joint as the left wrist, 10 denotes the human key point representing the skeletal joint as the right wrist, 11 denotes the human key point representing the skeletal joint as the left hip, 12 denotes the human key point representing the skeletal joint as the right hip, 13 denotes the human key point representing the skeletal joint as the left knee, 14 denotes the human key point representing the skeletal joint as the right knee, 15 denotes the human key point representing the skeletal joint as the left ankle, and 16 denotes the human key point representing the skeletal joint as the right ankle.

The target body part includes any one of the following: a length of a neck, a width of the shoulders, a length of a torso, a width of the hips, a length of the upper arm, a length of the lower arm, a length of a thigh, and a length of a calf. Among them, the length of the neck is equal to a length from the nose to a midpoint of a line connecting two shoulders (the human key point representing the skeletal joint as the left shoulder and the human key point representing the skeletal joint as the right shoulder), the width of the shoulders is equal to a length of a line connecting two shoulders, the length of the torso is equal to a length of a line connecting the midpoint of the line that connects two shoulders and a midpoint of a line that connects two hips (the human key point representing the skeletal joint as the left hip and the human key point representing the skeletal joint as the right hip), the width of the hips is equal to the length of the line connecting two hips, the length of the upper arm is equal to a length from the human key point representing the skeletal joint as the left shoulder to the human key point representing the skeletal joint as the left elbow, or the length of the upper arm is equal to a length from the human key point representing the skeletal joint as the right shoulder to the human key point representing the skeletal joint as the right elbow, the length of the lower arm is equal to a length from the human key point representing the skeletal joint as the left elbow to the human key point representing the skeletal joint as the left wrist, or the length of the lower arm is equal to a length from the human key point representing the skeletal joint as the right elbow to the human key point representing the skeletal joint as the right wrist, the length of the thigh is equal to a length from the human key point representing the skeletal joint as the left hip to the human key point representing the skeletal joint as the left knee, or the length of the thigh is equal to a length from the human key point representing the skeletal joint as the right hip to the human key point representing the skeletal joint as the right knee, the length of the calf is equal to a length from the human key point representing the skeletal joint as the left knee to the human key point representing the skeletal joint as the left ankle, or the length of the calf is equal to a length from the human key point representing the skeletal joint as the right knee to the human key point representing the skeletal joint as the right ankle.

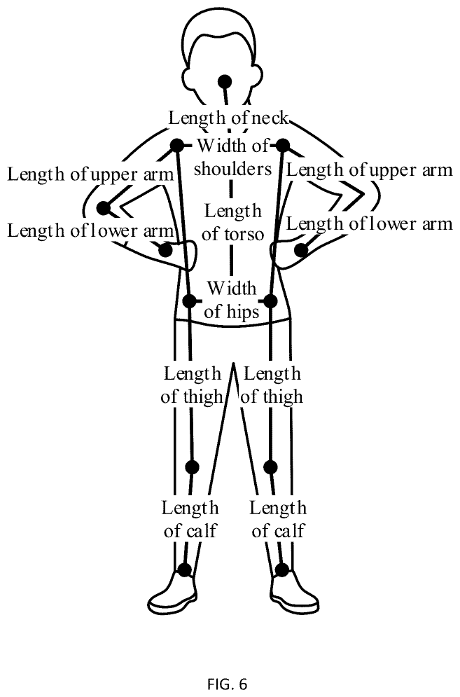

Exemplarily, the distribution of various body parts such as the length of the neck, the width of the shoulders, the length of the torso, the width of the hips, the length of the upper arm, the length of the lower arm, the length of the thigh and the length of the calf on the human body is shown in FIG. 6.

In some examples, in order to determine the position information of the human key points in the first frame image, a coordinate system needs to be established. For example, taking an upper left corner of the first frame image as a coordinate origin, a line connecting the coordinate origin to an upper right corner of the first frame image as an x-axis, and a line connecting the coordinate origin to a lower left corner of the first frame image as a y-axis, so that the position information of the human key points in the first frame image can be determined. After that, according to the position information of the human key points, the first actual length of the target body part and the second actual lengths of other body parts except the target body part can be determined.

It should be noted that the above example is described by taking the establishment of a rectangular coordinate system in the first frame image as an example. In some other examples, an operation and maintenance personnel can set the coordinate system according to actual needs, which is not limited in this application.

S13. A predicted length of the other body part except the target body part is determined according to a target proportional relationship and the first actual length. Where, the target proportional relationship includes a corresponding ratio of the first actual length to the predicted length of the other body part except the target body part.

In some examples, in order to draw the virtual digital human more vividly, in the method for generating the virtual digital human in the embodiments of the present application, a target body part is selected as a reference, and then the predicted lengths of other body parts are predicted through the first actual length corresponding to the target body part. For example, the predicted lengths of other body parts except the target body part are determined according to a product of the corresponding ratios of the first actual length to the predicted lengths of other body parts except the target body part and the first actual length.

Alternatively, the first actual length is input into a prediction model to determine the predicted lengths of other body parts except the target body part. A training process of the prediction model is as follows.

Training sample data and a labeled result of the training sample data are obtained. The training sample data includes a historical actual length of the target body part, and the labeled result includes historical predicted lengths of other body parts except the target body part.

The training sample data is input into a neural network model for training to obtain a prediction result of the neural network model for the training sample data.

Based on the prediction result and the labeled result, network parameters of the neural network model are adjusted until the neural network model converges to obtain a prediction model.

Exemplarily, taking the target body part as the width of the shoulders for an example, the target proportional relationship is shown in Table 1.

TABLE 1

| Body part | Length ratio r |
|---|---|
| Width of the shoulders | 1 |
| Length of the neck | 0.84 |
| Width of the hips | 0.62 |
| Length of the torso | 1.82 |
| Length of the upper arm | 1.04 |
| Length of the lower arm | 0.84 |
| Length of the thigh | 1.31 |
| Length of the calf | 1.47 |

When a first actual length corresponding to the width of the shoulders is 40 pixels, a predicted length corresponding to the length of the neck can be determined to be equal to 40×0.84=33.6, a predicted length corresponding to the width of the hips is equal to 40×0.62=24.8, a predicted length corresponding to the length of the torso is equal to 40×1.82=72.8, a predicted length corresponding to the length of the upper arm is equal to 40×1.04=41.6, a predicted length corresponding to the length of the lower arm is equal to 40×0.84=33.6, a predicted length corresponding to the length of the thigh is equal to 40×1.31=52.4, and a predicted length corresponding to the length of the calf is equal to 40×1.47=58.8.

In some other examples, since length ratios of different body parts in the human body are different, when the target body part changes, the corresponding target proportional relationship will also change.

Exemplarily, taking the target body part as the length of the neck for an example, the target proportional relationship is shown in Table 2.

TABLE 2

| Part | Length ratio r |
|---|---|
| Width of the shoulders | 1.19 |
| Length of the neck | 1 |
| Width of the hips | 0.74 |
| Length of the torso | 2.17 |
| Length of the upper arm | 1.24 |
| Length of the lower arm | 1 |
| Length of the thigh | 1.56 |
| Length of the calf | 1.75 |

When a first actual length corresponding to the length of the neck is 40 pixels, a predicted length corresponding to the width of the shoulders can be determined to be equal to 40×1.19=47.6, a predicted length corresponding to the width of the hips is equal to 40×0.74=29.6, a predicted length corresponding to the length of the torso is equal to 40×2.17=86.8, a predicted length corresponding to the length of the upper arm is equal to 40×1.24=49.6, a predicted length corresponding to the length of the lower arm is equal to 40×1=40, a predicted length corresponding to the length of the thigh is equal to 40×1.56=62.4, and a predicted length corresponding to the length of the calf is equal to 40×1.75=70.

S14. A drawing height of the other body part is determined based on the second actual length and the predicted length.

In some examples, in order to prevent the drawn virtual digital human from being deformed, the method for generating the virtual digital human in the embodiments of the present application corrects the predicted length according to the second actual length, to ensure that the drawn virtual digital human is more in line with the user's aesthetic standard and guarantee the user experience. For example, when the second actual length of the other body part is greater than the predicted length of the other body part, it is determined that the drawing height of the other body part is equal to the second actual length of the other body part; and when the second actual length of the other body part is less than or equal to the predicted length of the other body part, it is determined that the drawing height of the other body part is equal to the predicted length of the other body part. Or, the drawing height of the other body part is equal to an average value of the second actual length and the predicted length of the other body part.

In some examples, when the second actual length is less than the predicted length, during the process of drawing the virtual digital human according to the position information, it is necessary to translate key points corresponding to body parts (such as one or more of upward translation, downward translation, leftward translation and rightward translation), to ensure the integrity of the drawn virtual digital human. For example, only the predicted length corresponding to the width of the shoulders in the body parts is greater than the second actual length corresponding to the width of the shoulders; and in this case, in a direction of a line connecting the human key point representing the skeletal joint as the left shoulder and the human key point representing the skeletal joint as the right shoulder, with a midpoint of the line connecting two shoulders as a center, the human key point representing the skeletal joint as the left shoulder is translated to the left, and the human key point representing the skeletal joint as the right shoulder is translated to the right, so that a length of a line connecting the translated human key point representing the skeletal joint as the left shoulder and the translated human key point representing the skeletal joint as the right shoulder is equal to the predicted length. Or, when the predicted length corresponding to the length of the thigh in the body parts is greater than the second actual length corresponding to the length of the thigh, and the predicted length corresponding to the length of the calf in the body parts is greater than the second actual length corresponding to the length of the calf, it is necessary to translate the human key point representing the skeletal joint as the left knee downward on a line connecting the human key point representing the skeletal joint as the left hip and the human key point representing the skeletal joint as the left knee; at the same time, translate the human key point representing the skeletal joint as the left ankle downward on a line connecting the human key point representing the skeletal joint as the left knee and the human key point representing the skeletal joint as the left ankle; at the same time, translate the human key point representing the skeletal joint as the right knee downward on a line connecting the human key point representing the skeletal joint as the right hip and the human key point representing the skeletal joint as the right knee; and at the same time, translate the human key point representing the skeletal joint as the right ankle downward on a line connecting the human key point representing the skeletal joint as the right knee and the human key point representing the skeletal joint as the right ankle.

S15. A virtual digital human is generated by drawing based on the first actual length, the drawing height and the position information.

In some examples, when the user does different fitness actions, the position information of the human key points in the first frame image will also change. Therefore, in the method for generating the virtual digital human in the embodiments of the present application, the virtual digital human is drawn according to the position information of the human key points in the first frame image, the first actual length and the second actual length, so that the fitness action corresponding to the virtual digital human is the same as the user's current fitness action. Therefore, the users can intuitively know whether the fitness action they are currently doing is consistent with the fitness action of the target video played by the first application, which improves the user experience.

As can be seen from the above, when the users need the virtual digital human to be displayed, they can perform a selection operation on the target function. In this case, a target interface including a playback control for playing the target video and a preview control for displaying the virtual digital human can be displayed, so that the user can view the virtual digital human while watching the target video. Since the virtual digital human is drawn according to the actual position information of the user's human key points, the first actual length and the second actual length, the fitness action corresponding to the virtual digital human is the same as the user's current fitness action. Therefore, the users can intuitively know whether the fitness action they are currently doing is consistent with the fitness action of the target video played by the first application.

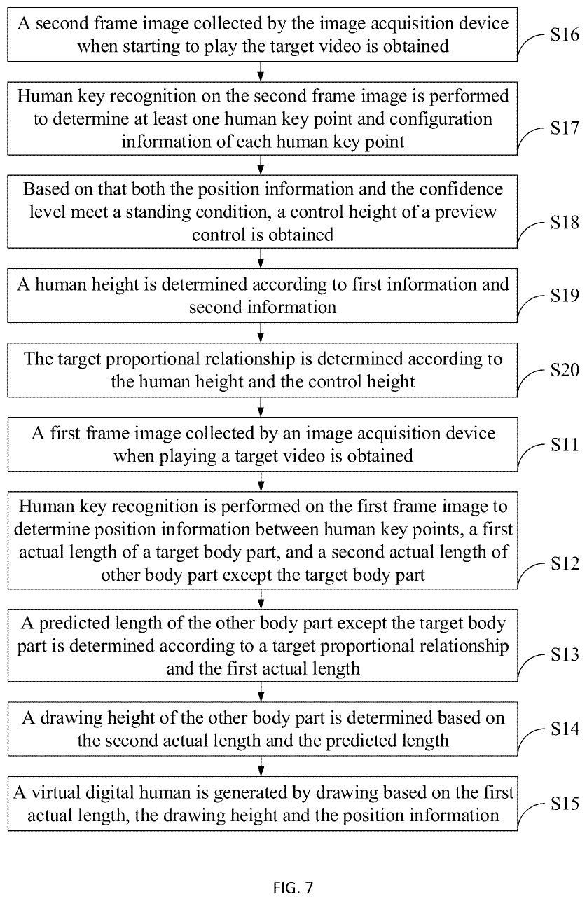

In some implementable examples, in combination with FIG. 4, as shown in FIG. 7, the method for generating the virtual digital human in the embodiments of the present application further includes: S16-S20.

S16. A second frame image collected by the image acquisition device when starting to play the target video is obtained. Where, the second frame image includes a human body facing the image acquisition device and performing the target action.

In some examples, users of different age groups correspond to different target proportional relationships. In order to ensure the accuracy of the drawn virtual digital human, the method for generating the virtual digital human in the embodiments of the present application assigns different target proportional relationships to users of different age groups. Therefore, when starting to play the target video, the human height can be determined by analyzing the second frame image collected by the image acquisition device. After that, the currently used target proportional relationship is determined according to the human height and the control height. For example, a first template is assigned to adults (users over 18 years old), and a second template is assigned to children (users under 18 years old). The current user is determined to belong to an adult or a child according to a magnitude relationship between a ratio of the human height to the control height and a preset threshold. For example, when the ratio of the human height to the control height is greater than the preset threshold, it indicates that the current user belongs to an adult, so the currently used target proportional relationship is determined to be the first template. Conversely, when the ratio of the human height to the control height is less than or equal to the preset threshold, it indicates that the current user belongs to a child, so the currently used target proportional relationship is determined to be the second template. In this way, when drawing the virtual digital human, different target proportional relationships can be used for users of different age groups, to ensure the accuracy of the generated virtual digital human and improve the user experience.

In some examples, the display apparatus 200 has a distance detection function. For example, a distance measuring sensor is disposed on the display apparatus 200. When the human body is far away from the display apparatus 200, the user can be prompted to approach the display apparatus 200. When the human body is close to the display apparatus 200, the user can be prompted to move away from the display apparatus 200. When the human body deviates from the display apparatus 200, the user can be prompted to stand again in an acquisition region of the image acquisition device. In this way, the integrity of the human body in the first frame image or the second frame image collected by the image acquisition device can be ensured, and the user experience can be guaranteed.

S17. Human key recognition on the second frame image is performed to determine at least one human key point and configuration information of each human key point. Where, the configuration information includes position information and a confidence level.

In some examples, when performing human key recognition on the second frame image, it is necessary to preprocess the second frame image to determine a preprocessed first image. After that, the first image is recognized to determine an actual detection frame corresponding to the human body. After that, the first image is cropped based on the actual detection frame to obtain a human body image of the human body. After that, the human body image is recognized to determine at least one target key point corresponding to the human body. Or, a human body detection algorithm is used for detecting the second frame image to determine at least one human key point.

Exemplarily, the preprocessing includes at least one of denoising, scaling, distortion correction, and stereo correction.

In some examples, recognizing the first image to determine the actual detection frame corresponding to the human body includes: separating a foreground and a background of the first image to obtain the corresponding foreground; after that, performing image recognition on the foreground to determine the human body contained in the foreground; and finally, by recognizing the human body, determining a smallest rectangle that is internally tangent to the human body, so that the smallest rectangle is used as the actual detection frame corresponding to the human body.

Or, a foreground and a background of the first image are separated to determine the foreground in the first image; after that, image recognition is performed on the foreground, so that the human body contained in the foreground can be determined; and finally, by recognizing the human body, a smallest rectangle that is internally tangent to the human body is determined, and the smallest rectangle is used as the actual detection frame corresponding to the human body. Or, the first image is input into the human body detection network to determine the actual detection frame corresponding to the human body.

Specifically, a training process of the human body detection network is as follows.

A training image and a labeled result of the training image are obtained.

The training image is input into a first target detection network to obtain a prediction result of the first target detection network for the training image. Herein, the first target detection network includes at least any one of a target detection algorithm YOLO (you only look once), a single shot multibox detector (SSD) algorithm, and a target detection algorithm Faster RCNN (faster region-based convolutional neural network).

When the labeled result is different from the prediction result, network parameters of the first target detection network are repeatedly adjusted until the target detection network converges to obtain the human body detection network.

In some examples, when cropping the frame image based on the actual detection frame, the actual detection frame and the frame image are first projected to determine an image, in the actual detection frame, of the frame image. After that, the foreground and the background of the image in the actual detection frame are separated to obtain the corresponding foreground. After that, image recognition is performed on the foreground, so that the human body contained in the foreground can be determined. Furthermore, the human body contained in the foreground is cropped to obtain the human body image of the human body.

In some examples, the second frame image can be input into a human key point detection network to determine at least one human key point and the configuration information of each human key point.

Specifically, a training process of the human key point detection network is as follows.

A training sample image and a training supervision image are obtained; herein, both the training sample image and the training supervision image include the human body, key points corresponding to the human body, and historical configuration information of each key point.

A second target detection network is trained based on the training sample image to obtain the pre-trained second target detection network.

Herein, the second target detection network includes at least any one of a heatmap-based human skeleton point detection network HRNet (high-resolution net), Simple Baseline, or a non-heatmap network whose output end is argmax.

Network parameters of the pre-trained second target detection network are adjusted based on the training supervision image until the pre-trained second target detection network converges to obtain the human key point detection network.

Or, human key recognition is performed on the second frame image by using the human key point detection algorithm to determine at least one human key point and the configuration information of each human key point.

In some examples, the human body detection algorithm includes: any one of a convolutional pose machines (CPM) algorithm or an OpenPose algorithm.

S18. Based on that both the position information and the confidence level meet a standing condition, a control height of a preview control is obtained. Herein, the preview control is configured to display the virtual digital human.

In some examples, in order to determine whether the human body meets the standing condition, it is necessary to select the human key points that can represent a standing state of the human body, such as: the human key point representing the skeletal joint as the nose, the human key point representing the skeletal joint as the left shoulder, the human key point representing the skeletal joint as the right shoulder, the human key point representing the skeletal joint as the left hip, the human key point representing the skeletal joint as the right hip, the human key point representing the skeletal joint as the left knee, the human key point representing the skeletal joint as the right knee, the human key point representing the skeletal joint as the left ankle, and the human key point representing the skeletal joint as the right ankle. After that, according to the position information and the confidence level of the human key points that can represent the standing state of the human body, it is determined whether the human body meets the standing condition. For example, it is determined that both the position information and the confidence level meet the standing condition based on the following: a confidence level of the human key point representing the skeletal joint as the nose, a confidence level of the human key point representing the skeletal joint as the left shoulder, a confidence level of the human key point representing the skeletal joint as the right shoulder, a confidence level of the human key point representing the skeletal joint as the left hip, a confidence level of the human key point representing the skeletal joint as the right hip, a confidence level of the human key point representing the skeletal joint as the left knee, a confidence level of the human key point representing the skeletal joint as the right knee, a confidence level of the human key point representing the skeletal joint as the left ankle, and a confidence level of the human key point representing the skeletal joint as the right ankle are all greater than a confidence level threshold; the position information of the human key point representing the skeletal joint as the nose, the position information of the human key point representing the skeletal joint as the left hip, the position information of the human key point representing the skeletal joint as the right hip, the position information of the human key point representing the skeletal joint as the left knee and the position information of the human key point representing the skeletal joint as the right knee meet a first condition; and an angle formed by the human key point representing the skeletal joint as the right hip, the human key point representing the skeletal joint as the right knee and the human key point representing the skeletal joint as the right ankle is greater than or equal to an angle threshold.

In some examples, when the users need to know whether the fitness action they are currently doing is consistent with the fitness action of the target video played by the first application, they can perform a selection operation on the target function provided by the first application. In this case, the first application responds to the selection operation on the target function and displays a target interface including the playback control for playing the target video and the preview control for displaying the virtual digital human. In this way, the user can view the virtual digital human while watching the target video. Since the fitness action corresponding to the virtual digital human is the same as the user's current fitness action, the users can intuitively know whether the fitness action they are currently doing is consistent with the fitness action of the target video played by the first application, which improves the user experience.

In some examples, a size of the actually generated virtual digital human is larger than a size of the preview control. In this case, the virtual digital human needs to be scaled according to a preset ratio and then is displayed in the preview control. Herein, the preset ratio can be set in advance, or can be determined according to the first actual length and a control height or a control width of the preview control. For example, when the target body part corresponding to the first actual length is the width of the shoulders, the preset ratio can be determined according to a ratio of the control width to the first actual length. Or, when the target body part corresponding to the first actual length is the length of the torso, the preset ratio can be determined according to a ratio of the control height to the first actual length.

S19. A human height is determined according to first information and second information. Herein, the first information includes the position information of the human key point representing the skeletal joint as the nose, and the second information includes the position information of the human key point representing the skeletal joint as the ankle.

S20. The target proportional relationship is determined according to the human height and the control height.

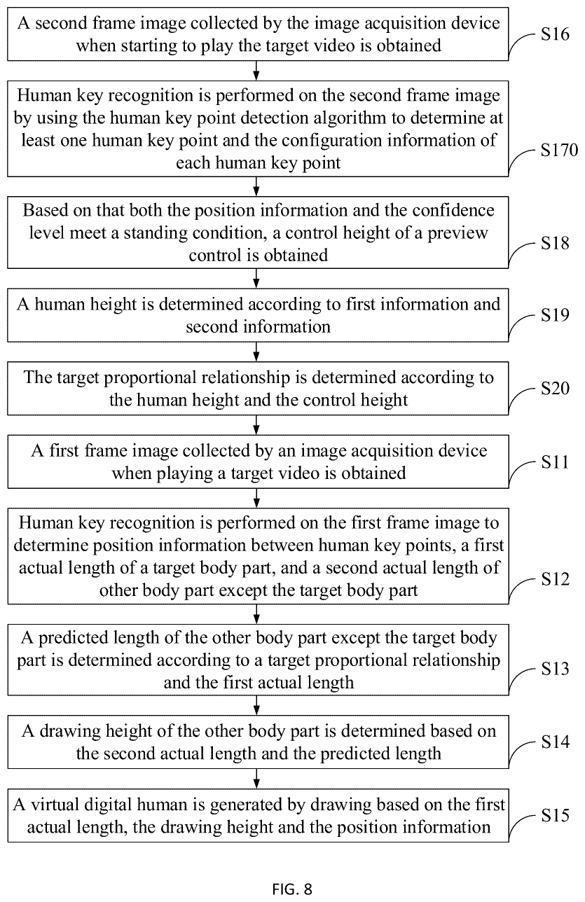

In some implementable examples, in combination with FIG. 7, as shown in FIG. 8, the above S17 can be specifically realized through the following S170.

S170. Human key recognition is performed on the second frame image by using the human key point detection algorithm to determine at least one human key point and the configuration information of each human key point.

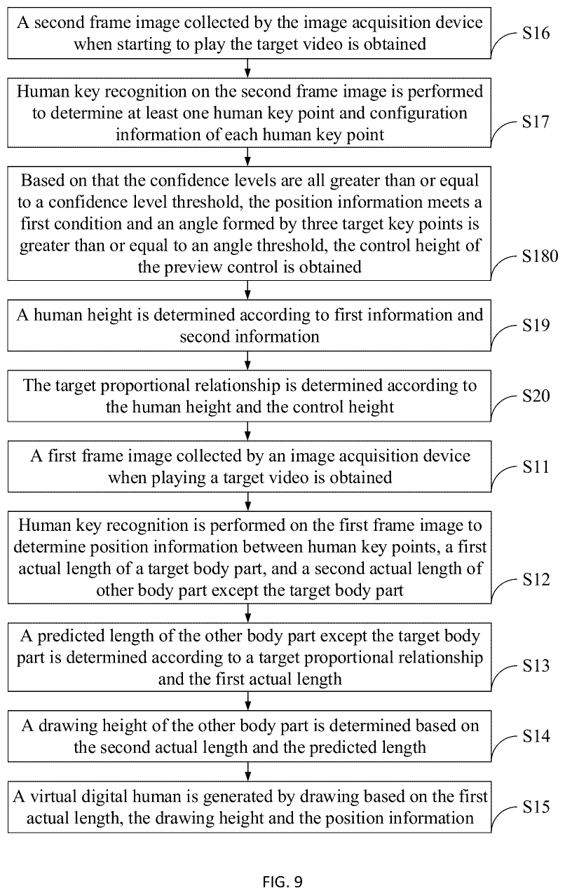

In some implementable examples, in combination with FIG. 7, as shown in FIG. 9, the above S18 can be specifically realized through the following S180.

S180. Based on that the confidence levels are all greater than or equal to a confidence level threshold, the position information meets a first condition and an angle formed by three target key points is greater than or equal to an angle threshold, the control height of the preview control is obtained. Herein, the target key point is any one of the human key points.

In some examples, three target key points can be the human key point representing the skeletal joint as the right hip, the human key point representing the skeletal joint as the right knee, and the human key point representing the skeletal joint as the right ankle. Then the angle formed by the three target key points is an angle formed by a line connecting the human key point representing the skeletal joint as the right knee and the human key point representing the skeletal joint as the right hip and a line connecting the human key point representing the skeletal joint as the right knee and the human key point representing the skeletal joint as the right ankle.

Exemplarily, the angle threshold can be 150°.

In some implementable examples, the position information includes at least ordinates, and the target body part includes the torso. The first condition includes: a sum of an ordinate of the human key point representing the skeletal joint as the nose and an obtained value is less than an ordinate of the human key point representing the skeletal joint as the left hip, an ordinate of the human key point representing the skeletal joint as the left knee is greater than or equal to an ordinate of the human key point representing the skeletal joint as the left hip, and an ordinate of the human key point representing the skeletal joint as the right knee is greater than or equal to an ordinate of the human key point representing the skeletal joint as the right hip; or, the sum of the ordinate of the human key point representing the skeletal joint as the nose and the obtained value is less than the ordinate of the human key point representing the skeletal joint as the right hip, the ordinate of the human key point representing the skeletal joint as the left knee is greater than or equal to the ordinate of the human key point representing the skeletal joint as the left hip, and the ordinate of the human key point representing the skeletal joint as the right knee is greater than or equal to the ordinate of the human key point representing the skeletal joint as the right hip. Herein, the obtained value is determined according to the length of the torso.

In some examples, the obtained value is equal to a product of a preset coefficient and the length of the torso. Herein, the preset coefficient is a constant.

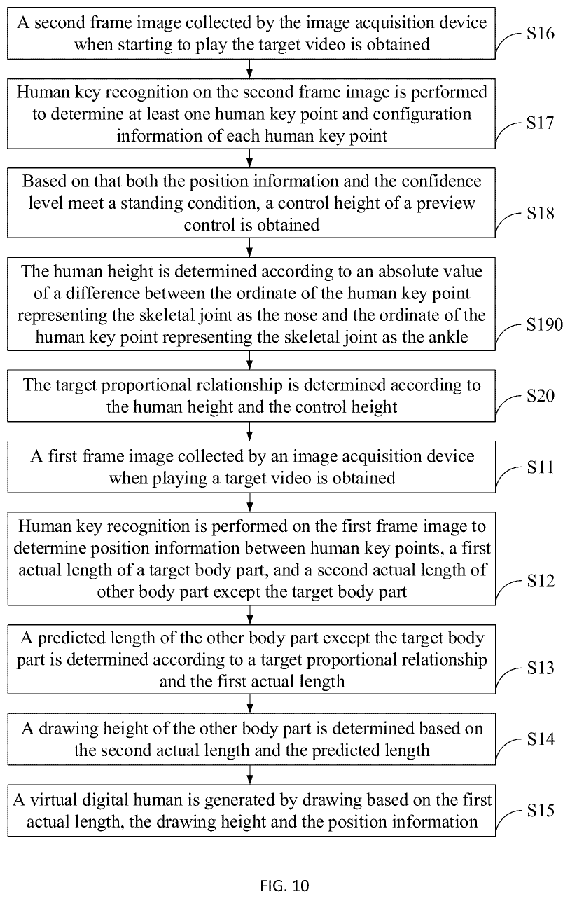

In some implementable examples, in combination with FIG. 7, as shown in FIG. 10, the above S19 can be specifically realized through the following S190.

S190. The human height is determined according to an absolute value of a difference between the ordinate of the human key point representing the skeletal joint as the nose and the ordinate of the human key point representing the skeletal joint as the ankle.

In some examples, the human height is equal to the absolute value of the difference between the ordinate of the human key point representing the skeletal joint as the nose and the ordinate of the human key point representing the skeletal joint as the ankle.

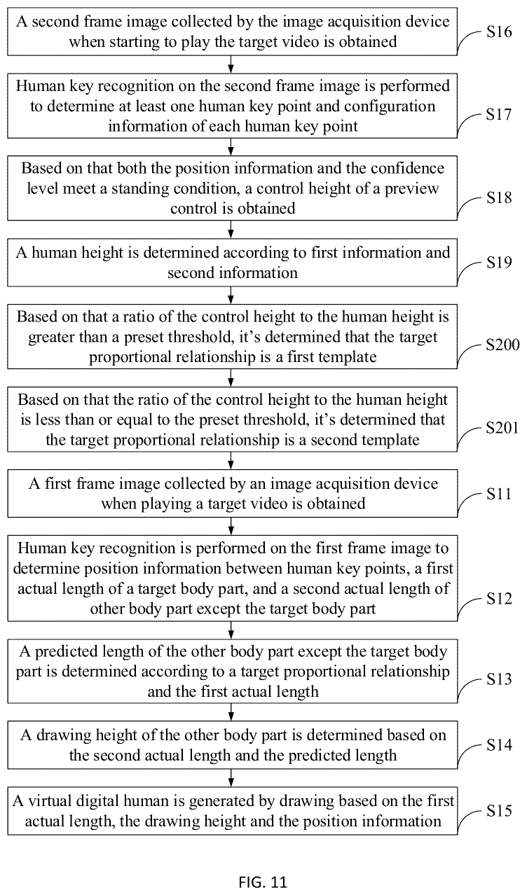

In some implementable examples, in combination with FIG. 7, as shown in FIG. 11, the above S20 can be specifically realized through the following S200 and S201.

S200. Based on that a ratio of the control height to the human height is greater than a preset threshold, it's determined that the target proportional relationship is a first template.

S201. Based on that the ratio of the control height to the human height is less than or equal to the preset threshold, it's determined that the target proportional relationship is a second template. Herein, both the first template and the second template include the corresponding ratios of the first actual length to actual lengths of other body parts except the target body part, and the corresponding ratios in the first template are different from the corresponding ratios in the second template.

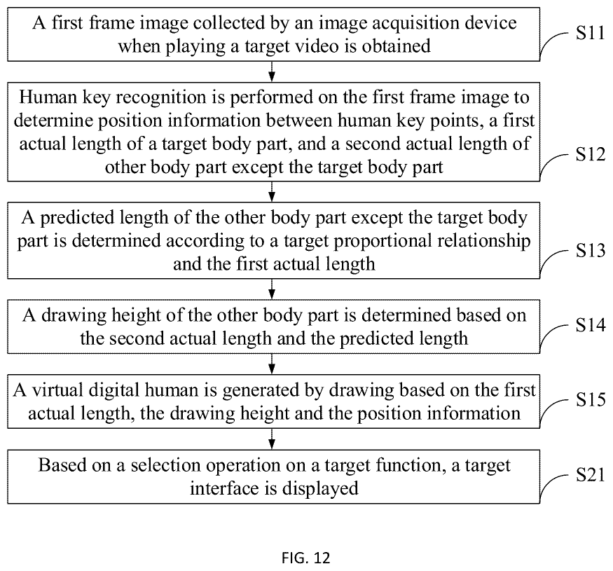

In some implementable examples, in combination with FIG. 7, as shown in FIG. 12, the method for generating the virtual digital human in the embodiments of the present application further includes: S21.

S21. Based on a selection operation on a target function, a target interface is displayed. Herein, the target interface includes the playback control for playing the target video and the preview control for displaying the virtual digital human.

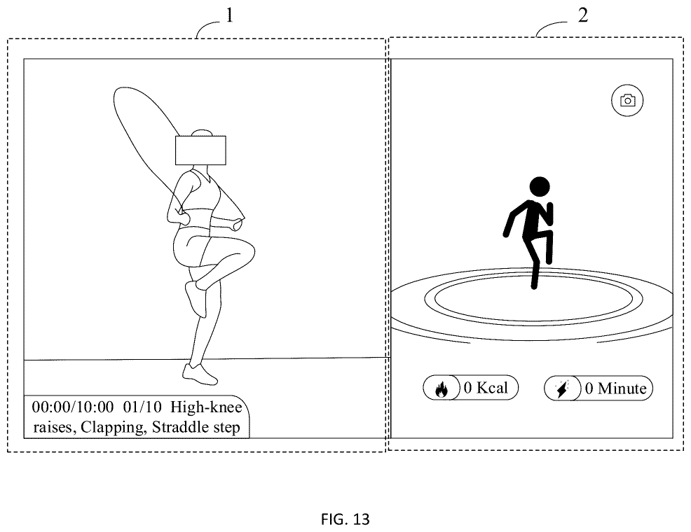

Exemplarily, when the users need to know whether the fitness action they are currently doing is consistent with the fitness action of the target video played by the first application, they can perform a selection operation on the target function provided by the first application. In this case, the first application responds to the selection operation on the target function and displays the target interface including the playback control 1 for playing the target video and the preview control 2 for displaying the virtual digital human as shown in FIG. 13. It can be seen that the user can view the virtual digital human while watching the target video. Since the fitness action corresponding to the virtual digital human is the same as the user's current fitness action, the users can intuitively know whether the fitness action they are currently doing is consistent with the fitness action of the target video played by the first application, which improves the user experience.

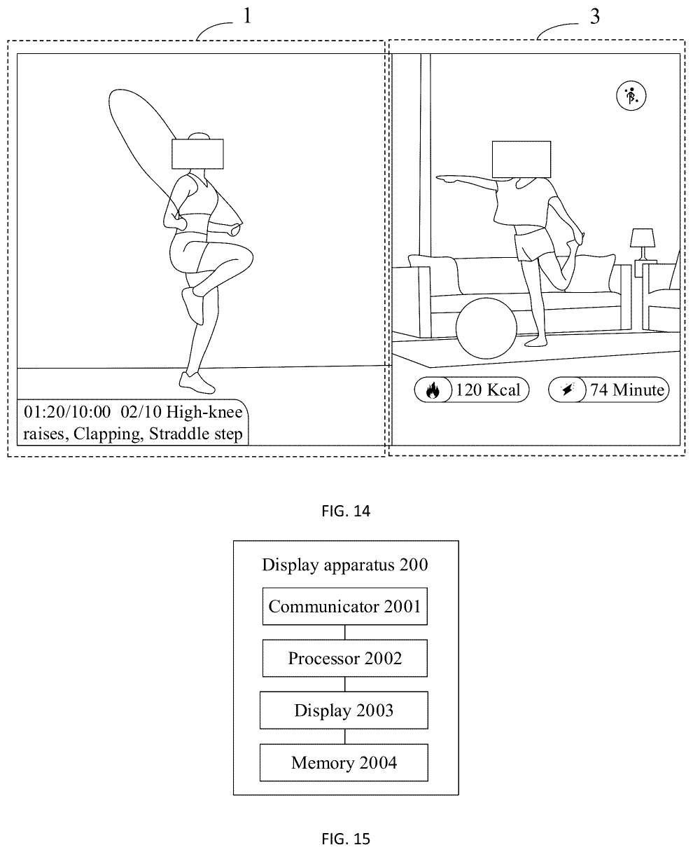

Or, when the users need to know whether the fitness action they are currently doing is consistent with the fitness action of the target video played by the first application, they can perform a selection operation on other function provided by the first application. In this case, the first application responds to the selection operation on other function and displays a preset interface including the playback control 1 for playing the target video and the preview control 3 for displaying a current environmental image as shown in FIG. 14. It can be seen that the users can view themselves while watching the target video. Therefore, the users can intuitively know whether the fitness action they are currently doing is consistent with the fitness action of the target video played by the first application, which improves the user experience.

The above mainly introduces the solution according to the embodiments of the present application from the perspective of the method. In order to achieve the above functions, it includes the corresponding hardware structures and/or software modules for executing various functions. Those skilled in the art should easily realize that, in combination with units and algorithm steps of each example described in the embodiments disclosed herein, the present application can be implemented in the form of hardware or a combination of hardware and computer software. Whether a certain function is executed in the form of hardware or computer software driving the hardware depends on the specific applications and design constraints of the technical solution. A professional can use different methods to implement the described functions for respective specific applications, but such implementation should not be regarded as going beyond the scope of the present application.

The embodiments of the present application can divide functional modules of the apparatus for generating the virtual digital human according to the above method examples. For example, various functional modules can be divided corresponding to various functions, or two or more functions can be integrated into one processing unit. The above integrated modules can be implemented in the form of hardware or in the form of software functional modules. It should be noted that the division of modules in the embodiments of the present application is illustrative, and is only a logical functional division. In actual implementation, there may be other division methods.

As shown in FIG. 15, an embodiment of the present application provides a schematic structural diagram of a display apparatus 200, including a communicator 2001 and a processor 2002.

The communicator 2001 is configured to obtain a first frame image collected by an image acquisition device when playing a target video. Herein, the target video includes at least one fitness action. The processor 2002 is configured to perform human key recognition on the first frame image obtained by the communicator 2001 to determine position information between human key points, a first actual length of a target body part, and a second actual length of other body part except the target body part. The processor 2002 is further configured to determine a predicted length of the other body part except the target body part according to a target proportional relationship and the first actual length. Herein, the target proportional relationship includes the corresponding ratio of the first actual length to the predicted length of the other body part except the target body part. The processor 2002 is further configured to determine a drawing height of the other body part based on the second actual length and the predicted length. The processor 2002 is further configured to generate a virtual digital human by drawing based on the first actual length, the drawing height and the position information.

In some implementable examples, the communicator 2001 is further configured to obtain the second frame image collected by the image acquisition device when starting to play the target video. Herein, the second frame image includes a human body facing the image acquisition device and doing the target action. The processor 2002 is further configured to perform human key recognition on the second frame image obtained by the communicator 2001 to determine at least one human key point and the configuration information of each human key point. Herein, the configuration information includes the position information and a confidence level. The processor 2002 is further configured to control the communicator 2001 to obtain the control height of the preview control when both the position information and the confidence level meet the standing condition. Herein, the preview control is configured to display the virtual digital human. The processor 2002 is further configured to determine the human height according to the first information and the second information. Herein, the first information includes the position information of the human key point representing the skeletal joint as the nose, and the second information includes the position information of the human key point representing the skeletal joint as the ankle. The processor 2002 is further configured to determine the target proportional relationship according to the human height and the control height.

In some implementable examples, the processor 2002 is specifically configured to perform human key recognition on the second frame image obtained by the communicator 2001 by using the human key point detection algorithm to determine at least one human key point and the configuration information of each human key point.

In some implementable examples, the processor 2002 is specifically configured to control the communicator 2001 to obtain the control height of the preview control when the confidence levels are all greater than or equal to the confidence level threshold, the position information meets the first condition, and the angle formed by three target key points is greater than or equal to the angle threshold. Herein, the target key point is any one of the human key points.

In some implementable examples, the position information includes at least the ordinates, and the target body part includes the torso. The first condition includes: the sum of the ordinate of the human key point representing the skeletal joint as the nose and the obtained value is less than the ordinate of the human key point representing the skeletal joint as the left hip, the ordinate of the human key point representing the skeletal joint as the left knee is greater than or equal to the ordinate of the human key point representing the skeletal joint as the left hip, and the ordinate of the human key point representing the skeletal joint as the right knee is greater than or equal to the ordinate of the human key point representing the skeletal joint as the right hip; or, the sum of the ordinate of the human key point representing the skeletal joint as the nose and the obtained value is less than the ordinate of the human key point representing the skeletal joint as the right hip, the ordinate of the human key point representing the skeletal joint as the left knee is greater than or equal to the ordinate of the human key point representing the skeletal joint as the left hip, and the ordinate of the human key point representing the skeletal joint as the right knee is greater than or equal to the ordinate of the human key point representing the skeletal joint as the right hip. Herein, the obtained value is determined according to the length of the torso.

In some implementable examples, the position information includes at least the ordinates. The processor 2002 is specifically configured to determine the human height according to the absolute value of the difference between the ordinate of the human key point representing the skeletal joint as the nose and the ordinate of the human key point representing the skeletal joint as the ankle.

In some implementable examples, the processor 2002 is specifically configured to determine that the target proportional relationship is the first template when the ratio of the control height to the human height is greater than the preset threshold. The processor 2002 is specifically configured to determine that the target proportional relationship is the second template when the ratio of the control height to the human height is less than or equal to the preset threshold. Herein, both the first template and the second template include the corresponding ratios of the first actual length to the actual lengths of other body parts except the target body part, and the corresponding ratio in the first template is different from the corresponding ratio in the second template.

In some implementable examples, the display apparatus 200 further includes a display 2003. The processor 2002 is further configured to control the display 2003 to display the target interface based on the selection operation on the target function. Herein, the target interface includes the playback control for playing the target video and the preview control for displaying the virtual digital human.

Wherein, all the relevant contents of various steps involved in the above method embodiments can be cited to the function description of the corresponding functional modules, and the function of which will not be repeated here.

Certainly, the display apparatus 200 according to the embodiments of the present application includes but is not limited to the above modules. For example, the display apparatus 200 may further include a memory 2004. The memory 2004 can be configured to store the program codes of the display apparatus 200, and can also be configured to store data generated during the operation of the display apparatus 200, such as the data in the request.

As an example, in combination with FIG. 3, functions implemented by the obtaining unit 210 and the receiving unit 213 in a server 400 are the same as functions implemented by the communicator 2001, functions implemented by the processing unit 211 are the same as functions implemented by the processor 2002, functions implemented by the display unit 212 are the same as functions implemented by the display 2003, and functions implemented by the storage unit 214 are the same as functions implemented by the memory 2004.

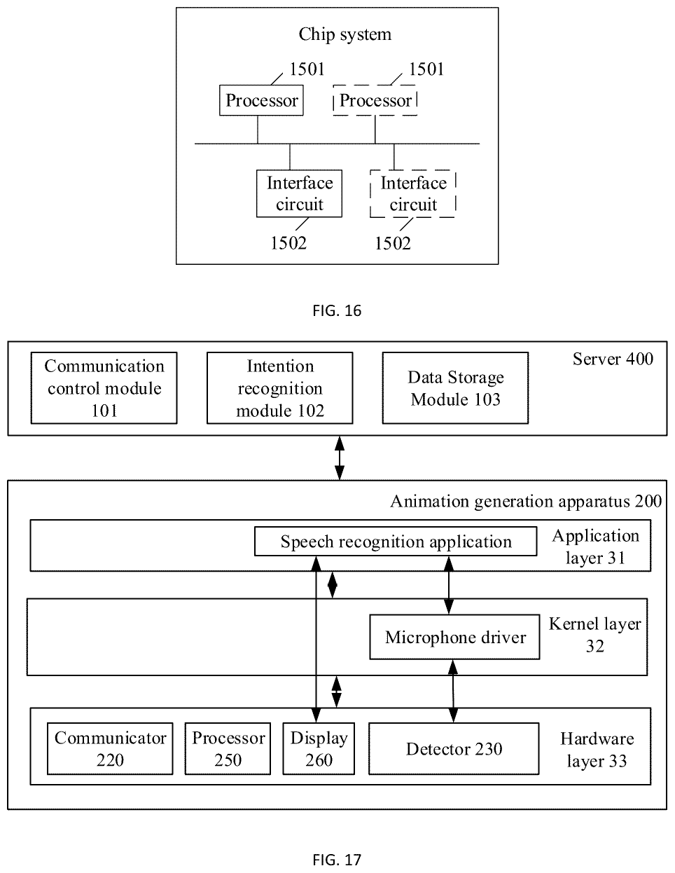

As shown in FIG. 16, embodiments of the present application further provide a chip system, which can be applied to the display apparatus 200 in the above embodiments. The chip system includes at least one processor 1501 and at least one interface circuit 1502. The processor 1501 may be the processor in the above display apparatus 200. The processor 1501 and the interface circuit 1502 can be interconnected through lines. The processor 1501 can receive computer instructions from the memory of the above display apparatus 200 through the interface circuit 1502 and execute computer instructions. When executed by the processor 1501, the computer instructions causes the display apparatus 200 to execute each step executed by the display apparatus 200 in the above embodiments. Certainly, the chip system may also include other discrete devices, which is not specifically limited in the embodiments of the present application.

The embodiments of the present application further provide a computer non-volatile readable storage medium, configured to store the computer instructions for the operation of the above display apparatus 200.

The embodiments of the present application further provide a computer program product, including the computer instructions for the operation of the above display apparatus 200.

In addition to the above embodiments, the present application also provides some other embodiments about animation generation, which are specifically described as follows.

In some embodiments, the processor includes at least one of a central processing unit (CPU), a video processor, an audio processor, a RAM, a ROM, a first interface to an n^{th} interface for input/output, a communication bus (Bus) and the like.

In some embodiments, taking an operating system of a smart apparatus as an Android system for an example, as shown in FIG. 17, an animation generation apparatus 200 can be logically divided into an application (Applications) layer 31, a kernel layer 32, and a hardware layer 33.

As shown in FIG. 17, the hardware layer may include the processor 250, the communicator 220, the detector 230 and the like shown in FIG. 2. The application layer 31 includes one or more applications. The application can be a system application or a third-party application. For example, the application layer 31 includes a speech recognition application, which can provide an animation generation interface and a service for the connection between the animation generation apparatus 200 and the server 400.

As a software middleware between the hardware layer and the application layer 31, the kernel layer 32 is configured to manage and control hardware and software resources.

In some embodiments, the kernel layer 32 includes a detector driver, which is configured to send voice data collected by the detector 230 to the speech recognition application. Exemplarily, when the speech recognition application in the animation generation apparatus 200 is started and a communication connection is established between the animation generation apparatus 200 and the server 400, the detector driver is configured to send voice data input by the user and collected by the detector 230 to the speech recognition application. After that, the speech recognition application sends query information containing the voice data to an intention recognition module 102 in the server. The intention recognition module 102 is configured to input the voice data sent by the animation generation apparatus 200 into the intention recognition module.

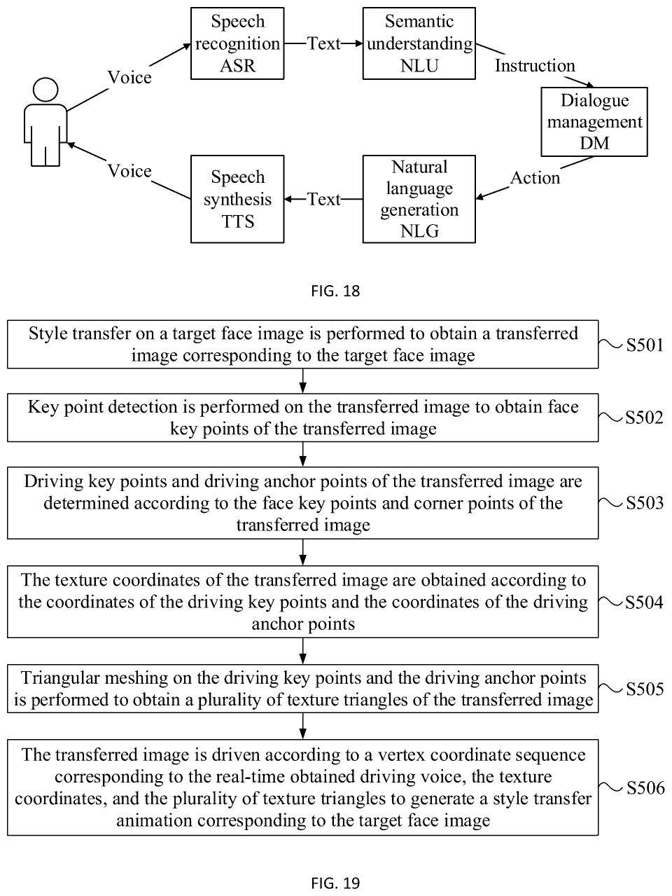

To clearly illustrate the embodiments of the present application, the following describes a speech recognition network architecture according to the embodiments of the present application in combination with FIG. 18.

Referring to FIG. 18, FIG. 18 is a schematic diagram of an animation generation network architecture according to embodiments of the present application. In FIG. 18, the animation generation apparatus is configured to receive input information and output a processing result of the information. A speech recognition module is deployed with a speech recognition service, which is configured to recognize the audio as the text; a semantic understanding module is deployed with a semantic understanding service, which is configured to perform semantic analysis on the text; a business management module is deployed with a business instruction management service, which is configured to provide a business instruction; a language generation module is deployed with a natural language generation (NLG) service, which is configured to convert the instruction for the animation generation apparatus to execute into the text language; and a speech synthesis module is deployed with a text-to-speech (TTS) service, which is configured to process the text language corresponding to the instruction and then send it to a speaker for broadcasting. In one embodiment, there may be multiple entity service devices deployed with different business services in the architecture shown in FIG. 18, or one or more entity service devices may integrate one or more functional services.

In some embodiments, the following gives an example to describe a process of processing the information input into the animation generation apparatus based on an architecture shown in FIG. 18. The information input into the animation generation apparatus as a voice instruction via voice input is taken as an example.

### [Speech Recognition].

After receiving the voice instruction via voice input, the animation generation apparatus can perform noise reduction processing and feature extraction on the audio of the voice instruction. The noise reduction processing may include steps such as removing echoes and environmental noises.

### [Semantic Understanding].

Using an acoustic model and a language model, natural language understanding is performed on the recognized candidate text and the associated context information, and the text is parsed into structured and machine-readable information, such as a business domain, intention and lexical slot, to express the semantics, etc. The executable intention is obtained and an intention confidence score is determined. The semantic understanding module selects one or more candidate executable intentions based on the determined intention confidence score.

### [Business Management].

According to a semantic analysis result of the text of the voice instruction, the semantic understanding module sends an execution instruction to the corresponding business management module to execute an operation corresponding to the voice instruction, complete the operation requested by the user, and feed back an execution result of the operation corresponding to the voice instruction.

In some embodiments, the processor 250 of the animation generation apparatus 200 is configured to perform style transfer on a target face image to obtain a transferred image corresponding to the target face image; perform key point detection on the transferred image to obtain face key points of the transferred image; determine driving key points and driving anchor points of the transferred image according to the face key points and corner points of the transferred image; obtain texture coordinates of the transferred image according to coordinates of the driving key points and coordinates of the driving anchor points; perform triangular meshing on the driving key points and the driving anchor points to obtain a plurality of texture triangles of the transferred image; and drive the transferred image according to a vertex coordinate sequence corresponding to the real-time obtained driving voice, the texture coordinates, and the plurality of texture triangles to generate a style transfer animation corresponding to the target face image.

In some embodiments, a mode that the processor 250 of the animation generation apparatus 200 is configured to perform style transfer on the target face image to obtain the transferred image corresponding to the target face image can be: generating the transferred image corresponding to the target face image according to the target face image and a style transfer model. Herein, the style transfer model is a generator in a generative adversarial network (GAN); and the generator includes: an encoder, an auxiliary classifier, an attention module, and a decoder. The encoder is configured to downsample an input image of the GAN to obtain a first downsampled image, process the first downsampled image through a convolutional residual block to obtain a residual feature, and perform instance normalization (IN) on the residual feature to obtain an encoded feature. The auxiliary classifier is configured to obtain weight coefficients of channels of the encoded feature. The attention module is configured to obtain an attention feature according to the weight coefficients of channels of the encoded feature and the encoded feature. The decoder is configured to perform IN or layer normalization (LN) on the attention feature to obtain a normalized feature and upsample the normalized feature to obtain an output image of the generator.

In some embodiments, the processor 250 of the animation generation apparatus 200 is further configured to, before generating the transferred image corresponding to the target face image according to the target face image and the style transfer model, obtain an original image set, where the original image set includes a plurality of sample face images and a plurality of sample transferred images; obtain face key points of images in the original image set; rotate and correct each image in the original image set according to the face key points of the images to obtain a corrected image set; scale a face bounding box corresponding to each image in the corrected image set to a preset size, and extract the image content within the scaled face bounding box to obtain a cropped image set, where the face bounding box corresponding to any image is a circumscribed square of the face key points of the image; set a background of each image in the cropped image set to a preset color to obtain a sample image set; and train the GAN based on the sample image set to obtain the style transfer model.

In some embodiments, a mode that the processor 250 of the animation generation apparatus 200 is configured to perform key point detection on the transferred image to obtain the face key points of the transferred image can be: performing key point detection on the transferred image based on a face key point detection model to obtain the face key points of the transferred image. The face key point detection model is a model obtained by training a preset machine learning model based on sample data, and the sample data includes: a plurality of sample face images and face key point information corresponding to each sample face image.

In some embodiments, the face key points of the transferred image of the animation generation apparatus 200 include 68 key points. The processor is specifically configured to: select 20 driving key points from mouth key points, left eye key points and right eye key points among the face key points; and set 8 driving anchor points according to the mouth key points, chin key points, nose key points, the left eye key points and the right eye key points among the face key points, and set 4 driving anchor points according to corner points of the transferred image.

In some embodiments, the processor 250 of the animation generation apparatus 200 is specifically configured to: perform normalization processing on the coordinates of the driving key points and the coordinates of the driving anchor points to obtain the texture coordinates of the transferred image. The processor is further configured to: process each coordinate value in the vertex coordinate sequence into a value within a range of [−1, 1].

In some embodiments, the processor 250 of the animation generation apparatus 200 is specifically configured to obtain a first offset sequence corresponding to the driving voice in real time; convert the first offset sequence into a second offset sequence corresponding to the transferred image according to a preset scaling parameter and a preset offset; and update the coordinates of the driving key points and the coordinates of the driving anchor points according to the second offset sequence to obtain the vertex coordinate sequence corresponding to the driving voice.

In some embodiments, the processor 250 of the animation generation apparatus 200 is specifically configured to convert a first vertex offset into a second vertex offset according to the preset scaling parameter, the preset offset, and the following formula:

$${δ}_{i}^{2} = {δ}_{i}^{1} / scale - shift$$

where, δᵢ² is an i^{th} offset in the second offset sequence, δᵢ¹ is an i^{th} offset in the first offset sequence, scale is the preset scaling parameter, and shift is the preset offset.

In some embodiments, the processor 250 of the animation generation apparatus 200 is further configured to: determine a target frequency according to a frame rate of the style transfer animation; and obtain the vertex coordinate sequence according to the target frequency.

FIG. 19 exemplarily shows a schematic flowchart of the animation generation method according to the embodiments of the present application. As shown in FIG. 19, the animation generation method according to the embodiments of the present application includes the following steps.

S501. Style transfer on a target face image is performed to obtain a transferred image corresponding to the target face image.

In some embodiments, the style transfer on the target face image is the conversion of the image in two different domains. Specifically, a style image is provided, and any image is converted into this style while retaining the content of the original image as much as possible.

S502. Key point detection is performed on the transferred image to obtain face key points of the transferred image.

In some embodiments, the key point detection is actually about conducting the relational description of the image. The face key points can represent not only the information of points but also the position information and associated information. The face key points of the face can be obtained through detection, and a pose of the face can be calculated according to them. Each key point in the face can represent the type characteristic of the face. For example, the key points of the eyes can represent a shape of the eyes and also the position information of the eyes on the face.

S503. Driving key points and driving anchor points of the transferred image are determined according to the face key points and corner points of the transferred image.

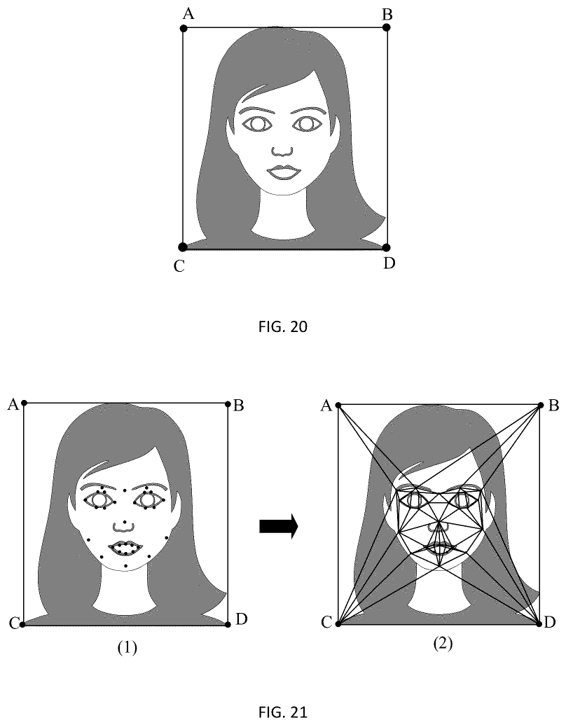

In some embodiments, the corner points of the transferred image are located at four vertices of the transferred image and are configured to fix the overall stretching effect of the transferred image. Referring to FIG. 20, there are four corner points A, B, C, and D at the four vertices of the transferred image 600, and positions indicated by the four points A, B, C, and D are corner point positions of the transferred image.

S504. The texture coordinates of the transferred image are obtained according to the coordinates of the driving key points and the coordinates of the driving anchor points.

In some embodiments, the coordinates of the driving key points and the coordinates of the driving anchor points can be expressed as Ref [a1, b1, c1], Ref [a2, b2, c2], etc., where a, b, and c represent position parameters of a coordinate.

S505. Triangular meshing on the driving key points and the driving anchor points is performed to obtain a plurality of texture triangles of the transferred image.

In some embodiments, the triangular meshing of the driving key points and the driving anchor points refers to the utilization of a Delaunay triangulation algorithm for the driving key points and the driving anchor points. Herein, the Delaunay triangulation is a process of generating a set of triangles for a given set of planar points. For example, in calculations such as finite element simulation and ray tracing rendering, it is necessary to convert a geometric model into triangular mesh data, that is, “triangular mesh generation”.

Exemplarily, referring to FIG. 21 which is a schematic diagram of a process of forming a plurality of texture triangles of the transferred image, the coordinate parameters of the driving key points and the driving anchor points are input by using the subdiv.gettrianglelist method; and according to an empty circle property of Delauney triangulation and a rule of the maximization of the minimum angle, the points are connected into triangles, and triangle indices are output. The Delauney triangular mesh is unique and the closest to a regular triangular network no matter where it starts to be constructed, which can optimize the subsequent stretching effect on a terminal side and improve the stretching efficiency.

S506. The transferred image is driven according to a vertex coordinate sequence corresponding to the real-time obtained driving voice, the texture coordinates, and the plurality of texture triangles to generate a style transfer animation corresponding to the target face image.

In some embodiments, the driving voice can be obtained by identifying the user's voice through intelligent technologies such as speech semantic recognition, or directly obtained from a cloud voice library according to the current scene content.

In some embodiments, steps of the method for obtaining the vertex coordinate sequence corresponding to the real-time obtained driving voice include the following steps A to D.

Step A. A first offset sequence corresponding to the driving voice is obtained in real time.

In some embodiments, the way of obtaining the first offset sequence corresponding to the driving voice can be to receive key point offsets driven by the voice from the cloud. For example, when there are 32 key points, the first offset sequence can be expressed as: Delta [A₁, B₁, C₁]_{N}, Delta [A₂, B₂, C₂]_{N}, . . . . Delta [A₃₂, B₃₂, C₃₂]_{N}.

Step B. The first offset sequence is converted into the second offset sequence corresponding to the transferred image according to a preset scaling parameter and a preset offset.

In some embodiments, the preset scaling parameter is a floating-point number, and the preset offset can be expressed as [x_, y_, z_].

Step C. The first vertex offset is converted into the second vertex offset according to the preset scaling parameter, the preset offset, and the following formula:

$${δ}_{i}^{2} = {δ}_{i}^{1} / scale - shift$$

herein, δᵢ² is an i^{th} offset in the second offset sequence, δᵢ¹ is an i^{th} offset in the first offset sequence, scale is the preset scaling parameter, and shift is the preset offset.

In some embodiments, the preset scaling parameter and the preset offset can be obtained by multiple manual adjustments according to different transferred cartoon images.

Step D. The coordinates of the driving key points and the coordinates of the driving anchor points are updated according to the second offset sequence to obtain the vertex coordinate sequence corresponding to the driving voice.

From the above technical solutions, in the animation generation apparatus and method according to the embodiments of the present application, the processor is configured to: perform style transfer on the target face image to obtain the transferred image corresponding to the target face image; perform key point detection on the transferred image to obtain the face key points of the transferred image; determine the driving key points and driving anchor points of the transferred image according to the face key points and the corner points of the transferred image; obtain the texture coordinates of the transferred image according to the coordinates of the driving key points and the coordinates of the driving anchor points; perform triangular meshing on the driving key points and the driving anchor points to obtain a plurality of texture triangles of the transferred image; and drive the transferred image according to the vertex coordinate sequence corresponding to the real-time obtained driving voice, the texture coordinates and the plurality of texture triangles to generate the style transfer animation corresponding to the target face image. Compared with the prior art in which the generated style transfer animation has poor effect and low aesthetic appeal, in the application, triangular meshing is performed on the style transfer image to make the obtained transferred image have a better stretching effect, and further make the generated animation effect better and improve the user experience.

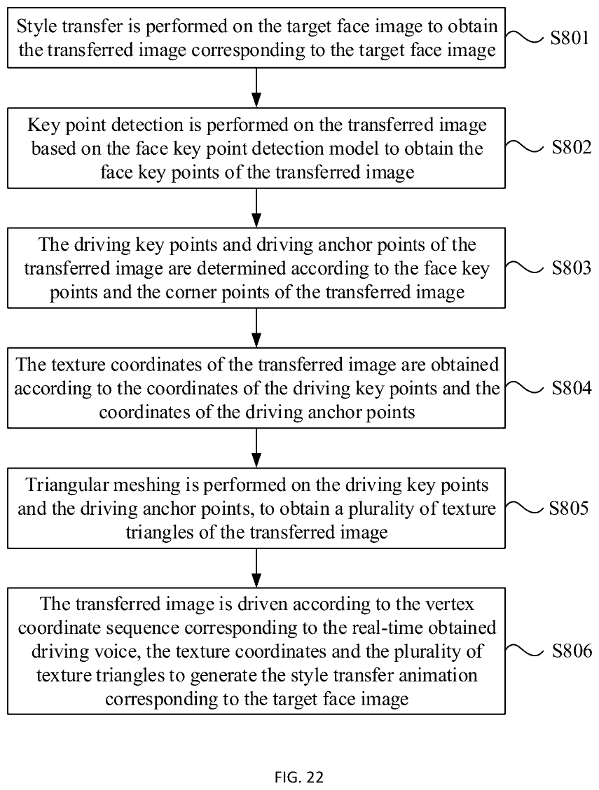

As an extension and refinement of the above embodiments, FIG. 22 exemplarily shows a schematic flowchart of the animation generation method according to the embodiments of the present application. As shown in FIG. 22, the animation generation method according to the embodiments of the present application includes the following steps.

S801. Style transfer is performed on the target face image to obtain the transferred image corresponding to the target face image.

S802. Key point detection is performed on the transferred image based on the face key point detection model to obtain the face key points of the transferred image.

The face key point detection model is a model obtained by training a preset machine learning model based on sample data, and the sample data includes: a plurality of sample face images and face key point information corresponding to each of the sample face images.

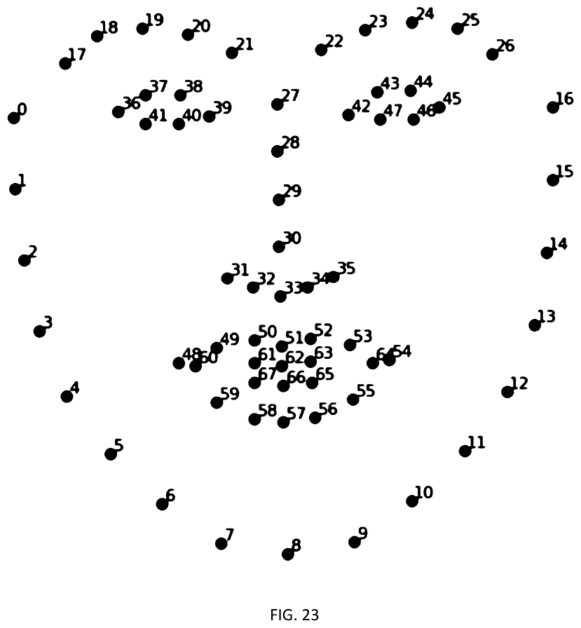

In the above S802, the face key points of the transferred image include 68 key points, referring to FIG. 23 which is a schematic diagram of 68 face key points in the transferred image. The method for obtaining the face key points of the transferred image includes the following step 1 and step 2.

Step 1. 20 driving key points are selected from mouth key points, left eye key points, and right eye key points among the face key points.

In some embodiments, referring to FIG. 23 which is a schematic diagram of positions of 68 face key points in the transferred image, among the 68 face key points, 8 key points are selected from the mouth key points, 6 key points are selected from the left eye key points and 6 key points are selected the right eye key points. The 20 key points are use as driving key points.

Step 2. 8 driving anchor points are set according to the mouth key points, the chin key points, the nose key points, the left eye key points and the right eye key points among the face key points; and 4 driving anchor points are set according to the corner points of the transferred image.

In some embodiments, a total of 8 key points are selected from the mouth key points, the chin key points, the nose key points, the left eye and the right eye key points among the face key points as the driving anchor points, which are used for controlling the stretching of surrounding regions caused by removing key points of the driving parts. Exemplarily, referring to FIG. 21, positions of 32 key points including the driving key points and the driving anchor points refer to (1) in FIG. 21.

It should be noted that the selection of key points and the setting of anchor points need follow the following two principles to ensure the stretching effect.

Principle 1: the key points of the eyes and mouth are finely adjusted to ensure the symmetry of the overall coordinates of the key points and the envelopment of the part.

Principle 2: different anchor point positions need to be set for different images. In principle, the effectiveness of the result of the triangulation algorithm shall prevail.

S803. The driving key points and driving anchor points of the transferred image are determined according to the face key points and the corner points of the transferred image.

S804. The texture coordinates of the transferred image are obtained according to the coordinates of the driving key points and the coordinates of the driving anchor points.

In the above S804, the method of obtaining the texture coordinates of the transferred image according to the coordinates of the driving key points and the coordinates of the driving anchor points further includes: performing normalization processing on the coordinates of the driving key points and the coordinates of the driving anchor points to obtain the texture coordinates of the transferred image.

In some embodiments, a value range of the texture coordinates is from 0 to 1. Therefore, it is necessary to normalize the coordinates of the driving key points and the coordinates of the driving anchor points to a space of [0, 1]. Exemplarily, a scaling method can be dividing the coordinates of the driving key points and the coordinates of the driving anchor points by a pixel width of the stretched image (square).

S805. Triangular meshing is performed on the driving key points and the driving anchor points, to obtain a plurality of texture triangles of the transferred image, for example, as shown in FIG. 21 (2).

S806. The transferred image is driven according to the vertex coordinate sequence corresponding to the real-time obtained driving voice, the texture coordinates and the plurality of texture triangles to generate the style transfer animation corresponding to the target face image.

In the above S806, it also includes: processing each coordinate value in the vertex coordinate sequence into a value within [−1, 1].

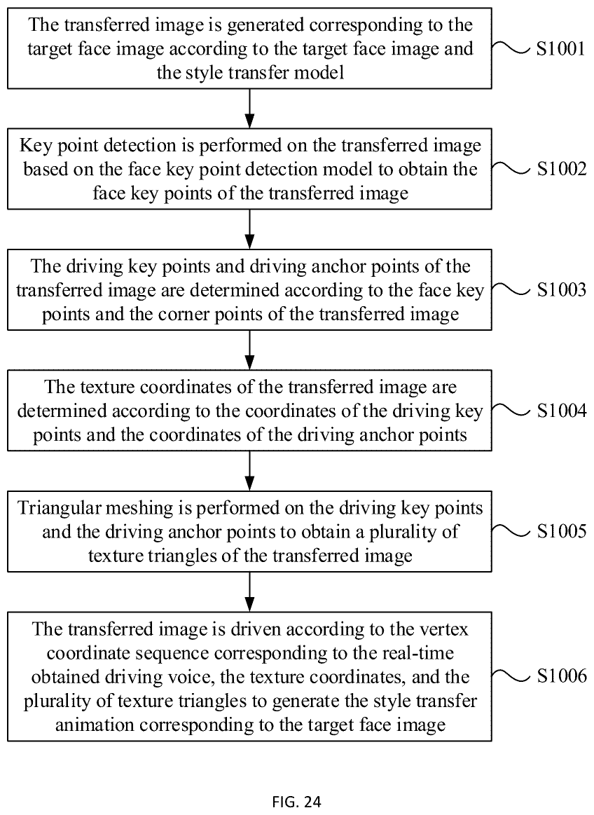

As an extension and refinement of the above embodiments, FIG. 24 exemplarily shows a schematic flowchart of the animation generation method according to the embodiments of the present application. As shown in FIG. 24, the animation generation method according to the embodiments of the present application includes the following steps.

S1001. The transferred image is generated corresponding to the target face image according to the target face image and the style transfer model.

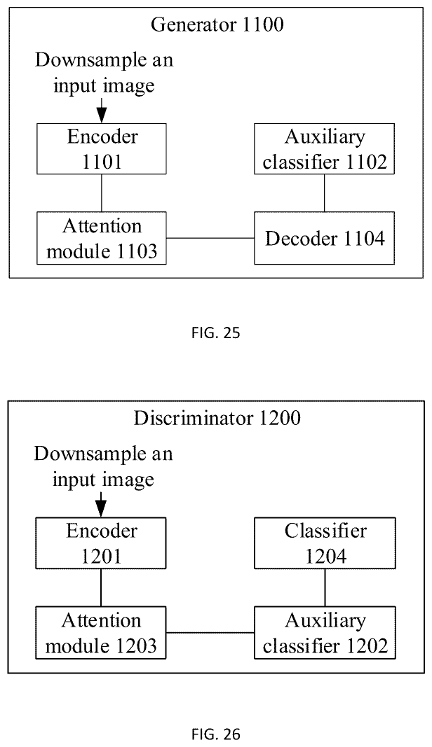

Herein, the style transfer model is a generator in the generative adversarial network (GAN). The generator includes: an encoder, an auxiliary classifier, an attention module, and a decoder. In some embodiments, referring to FIG. 25, the generator 1100 in the GAN includes:
an encoder 1101, configured to downsample an input image of the GAN to obtain a first downsampled image, process the first downsampled image through a convolutional residual block to obtain a residual feature, and perform IN on the residual feature to obtain an encoded feature;
an auxiliary classifier 1102, configured to obtain a weight coefficient of each channel of the encoded feature;
an attention module 1103, configured to obtain an attention feature according to the weight coefficient of each channel of the encoded feature and the encoded feature; and
a decoder 1104, configured to perform IN or LN on the attention feature to obtain a normalized feature and upsample the normalized feature to obtain an output image of the generator.

The style transfer model also includes a discriminator in the GAN. Referring to FIG. 26, the discriminator 1200 in the GAN includes: an encoder 1201, an auxiliary classifier 1202, an attention module 1203, and a classifier 1204. The structure of the discriminator is basically the same as that of the generator. The difference is that the generator and the discriminator use different loss functions when training the classifier.

Before generating the transferred image corresponding to the target face image according to the target face image and the style transfer model, it is also necessary to obtain the style transfer model. The method of obtaining the style transfer model includes the following steps 1 to 6.

Step 1, an original image set is obtained, and the original image set includes a plurality of sample face images and a plurality of sample transferred images.

Step 2, face key points of each image in the original image set are obtained.

Step 3, each image in the original image set is rotated and corrected according to the face key points of each image to obtain a corrected image set.

Step 4, a face bounding box corresponding to each image in the corrected image set is scaled to a preset size, and the image content within the scaled face bounding box is extracted to obtain a cropped image set; and the face bounding box corresponding to any image is a circumscribed square of the face key points of the image.

Step 5, a background of each image in the cropped image set is set to a preset color to obtain a sample image set.

Step 6, the GAN is trained based on the sample image set to obtain the style transfer model.

In some embodiments, when obtaining the style transfer model, it is also necessary to set a loss function, to calculate a difference between a forward calculation result of each iteration of a neural network and a true value, so as to guide the next step of training in a correct direction. Among them, in the embodiments of the present application, there are a total of four loss functions, namely Adversarial loss, Cycle loss, Identity loss, and class activation mapping (CAM) loss.

Specifically, a function Gs->t is trained, which maps a source domain Xs to a target domain Xt. Mismatched samples sampled from the two domains respectively are used during training. Our framework includes generators Gs->t and Gt->s, and two discriminators Ds and Dt. The attention module in the discriminator helps the generator focus on the most important region for generating realistic images, and the attention of the generator focuses on a key part that distinguishes the source domain from other domains.

Let x∈{Xt, Gs->t (Xs)} represent a sample from the target domain or a generated sample. Dₜ includes encoder—EDt, classifier CDt, and auxiliary classifier ηDt. ηDt(x) and Dt(x) are used for identifying whether x comes from Xt or Gs->t(Xs).

Adversarial loss: the mean squared error (MSE) is used for calculation to make the distribution of the translated image match the distribution of the target image. The expression of the loss function is as follows:

$${L}_{lsgan}^{s \to t} = {E}_{x ∼ {X}_{t}} [ {( {D}_{t} ( t ) )}^{2} ] + {E}_{x ∼ {X}_{s}} [ {( 1 - {D}_{t} ( {G}_{s \to t} ( x ) ) )}^{2} ] .$$

Cycle loss: the cycle loss is to alleviate the problem of mode collapse, and the cycle consistency constraint is applied to the generator. Given an image x∈Xs, after the sequential transformation of x from Xs to Xt and from Xt to Xs, the image should be successfully transformed back to the original domain. The expression of the loss function is as follows:

$${L}_{cycle}^{s \to t} = {E}_{x ∼ {X}_{s}} [ {\vert x - {G}_{t \to s} ( {G}_{s \to t} ( x ) \vert}_{1} ] .$$

Identity loss: a regression loss function L1 loss is adopted. The identity loss is to ensure that the color distribution of an input image and an output image is similar, and the identity consistency constraint is applied to the generator. Given an image x∈Xt, after transforming X using Gs→t, the image should not change. The expression of the loss function is as follows:

$${L}_{identity}^{s \to t} = {E}_{x ∼ {X}_{t}} [ {\vert x - {G}_{s \to t} ( x ) \vert}_{1} ] .$$

CAM loss: the Binary Cross Entropy (BCE) Loss is used for calculation in the generator, and the MSE loss is used for calculation in the discriminator. The information of the auxiliary classifier is used for calculating the maximum difference between the target domain and the source domain.

The expression of the loss function in the generator is as follows:

$${L}_{cam}^{s \to t} = - ( {E}_{x \to {X}_{s}} [ log ( {η}_{s} ( x ) ) ] ) + {E}_{x ∼ {X}_{t}} [ log ( 1 - {η}_{s} ( x ) ) ] .$$

The expression of the loss function in the discriminator is as follows:

$${L}_{cam}^{{D}_{t}} = {E}_{x \to {X}_{t}} [ {( η {D}_{t} ( x ) )}^{2} ] + {E}_{x ∼ {X}_{s}} [ {( 1 - η {D}_{t} ( {G}_{s \to t} ( x ) ) )}^{2} ] .$$

Herein, ηs(x) represents a probability that x comes from Xs, and ηDₜ(x) represents a probability that x comes from Dₜ.

S1002. Key point detection is performed on the transferred image based on the face key point detection model to obtain the face key points of the transferred image.

Herein, the face key point detection model is a model obtained by training a preset machine learning model based on sample data, and the sample data includes: a plurality of sample face images and the face key point information corresponding to each sample face image.

S1003. The driving key points and driving anchor points of the transferred image are determined according to the face key points and the corner points of the transferred image.

S1004. The texture coordinates of the transferred image are determined according to the coordinates of the driving key points and the coordinates of the driving anchor points.

S1005. Triangular meshing is performed on the driving key points and the driving anchor points to obtain a plurality of texture triangles of the transferred image.

S1006. The transferred image is driven according to the vertex coordinate sequence corresponding to the real-time obtained driving voice, the texture coordinates, and the plurality of texture triangles to generate the style transfer animation corresponding to the target face image.

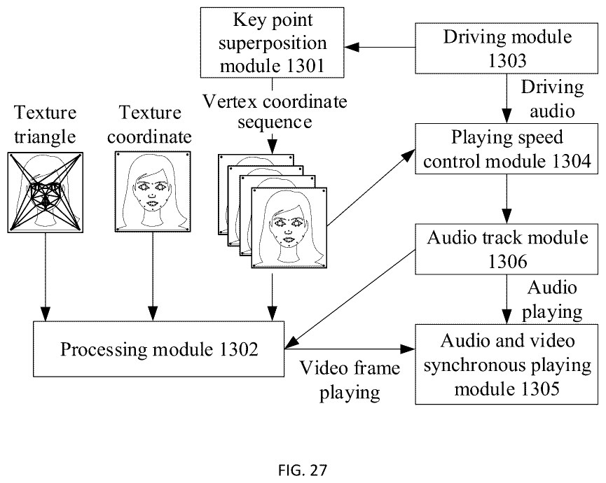

As an extension and refinement of the above embodiments, referring to FIG. 27 which is a schematic diagram of the overall framework of the animation generation method, the framework includes:
a key point superposition module 1301, configured to obtain the vertex coordinate sequence;
a processing module 1302, configured to drive the transferred animation, and control the alignment of audio and video according to the vertex coordinate sequence corresponding to the obtained driving voice, the texture coordinates, and the plurality of texture triangles. Herein, the processing module includes an open graphics library for embedded systems (OpenGL ES) renderer, a vertex array object (VAO) area, a vertex buffer object (VBO) area, a verter processor, and a shader. In some embodiments, the alignment of audio and video is controlled by the speed of inputting vertex coordinates (rendering speed), and a sequence frame rate of the generated vertex coordinate sequence is 80 FPS (frames per second), so the rendering speed based on the open graphics library (OpenGL) is 12.5 ms/frame. Generally, frames can be selected at intervals from the vertex coordinate sequence. For example, if one frame is selected every 4 frames, the frame rate will become 20 FPS, and the rendering speed is 50 ms/frame;
a driving module 1303, configured to obtain the driving audio and control the key point superposition module 1301 to generate the vertex coordinate sequence in real time;
a playing speed control module 1304, configured to control the playing speed of the animation;
an audio and video synchronous playing module 1305, configured to play the audio and video synchronously; and
an audio track module 1306, configured to obtain the audio and video of the animation to be played.

In some embodiments, the embodiments of the present application provide a computer non-volatile readable storage medium. Computer programs are stored on the computer non-volatile readable storage medium. When executed by a computing device, computer programs enable the computing device to implement the animation generation method described in any of the above embodiments.

In some embodiments, the embodiments of the present application provide a computer program product. When the computer program product runs on a computer, the computer program product enables the computer to implement the animation generation method described in the first aspect or any embodiment of the first aspect.

The above are only the specific implementation manners of the present application, enabling those skilled in the art to understand or implement the present application. Various modifications to these embodiments will be obvious to those skilled in the art, and the general principles defined herein can be implemented in other embodiments without departing from the spirit or scope of the present application. Therefore, the present application will not be limited to the embodiments described herein, but should conform to the widest scope consistent with the principles and novel features disclosed herein.

What is claimed is:

1. A method for generating a virtual digital human, comprising:
obtaining a first frame image collected by an image acquisition device when playing a target video; wherein the target video comprises at least one fitness action;
performing human key recognition on the first frame image, to determine position information between human key points, a first actual length of a target body part, and a second actual length of other body part except the target body part;
determining a predicted length of the other body part except the target body part according to a target proportional relationship and the first actual length; wherein the target proportional relationship comprises a corresponding ratio of the first actual length to the predicted length of the other body part except the target body part;
determining a drawing height of the other body part based on the second actual length and the predicted length; and
generating the virtual digital human by drawing based on the first actual length, the drawing height, and the position information.

2. The method according to claim 1, wherein before obtaining the first frame image collected by the image acquisition device when playing the target video, the method further comprises:
obtaining a second frame image collected by the image acquisition device when starting to play the target video; wherein the second frame image comprises a human body facing the image acquisition device and performing a target action;
performing human key recognition on the second frame image to determine at least one human key point and configuration information of each of the at least one human key point; wherein the configuration information comprises the position information and a confidence level;
based on that both the position information and the confidence level meet a standing condition, obtaining a control height of a preview control; wherein the preview control is configured to display the virtual digital human;
determining a human height according to first information and second information; wherein the first information comprises position information of the human key point representing a skeletal joint as a nasal, and the second information comprises position information of the human key point representing a skeletal joint as an ankle; and
determining the target proportional relationship according to the human height and the control height.

3. The method according to claim 2, wherein the performing of human key recognition on the second frame image to determine at least one human key point and configuration information of each of the at least one human key point, comprises:
performing human key recognition on the second frame image by using a human key point detection algorithm to determine the at least one human key point and the configuration information of each of the at least one human key point.

4. The method according to claim 2, based on that both the position information and the confidence level meet the standing condition, the obtaining of the control height of the preview control, comprises:
based on that the confidence level is greater than or equal to a confidence threshold, the position information meets a first condition, and an angle formed by three target key points is greater than or equal to an angle threshold, obtaining the control height of the preview control; wherein the target key point is any one of the at least one human key point.

5. The method according to claim 4, wherein the position information comprises at least ordinates, and the target body part comprises a torso;
wherein the first condition comprises:
a sum of an ordinate of the human key point representing the skeletal joint as the nasal and an obtained value is less than an ordinate of the human key point representing the skeletal joint as a left hip, an ordinate of the human key point representing the skeletal joint as a left knee is greater than or equal to an ordinate of the human key point representing the skeletal joint as the left hip, and an ordinate of the human key point representing the skeletal joint as a right knee is greater than or equal to an ordinate of the human key point representing the skeletal joint as a right hip;
or,
the sum of the ordinate of the human key point representing the skeletal joint as the nasal and the obtained value is less than the ordinate of the human key point representing the skeletal joint as the right hip, the ordinate of the human key point representing the skeletal joint as the left knee is greater than or equal to the ordinate of the human key point representing the skeletal joint as the left hip, and the ordinate of the human key point representing the skeletal joint as the right knee is greater than or equal to the ordinate of the human key point representing the skeletal joint as the right hip;
wherein the obtained value is determined according to a length of the torso.

6. The method according to claim 2, wherein the position information comprises at least ordinates;
wherein the determining of the human height according to the first information and the second information, comprises:
determining the human height according to an absolute value of a difference between an ordinate of the human key point representing the skeletal joint as the nasal and an ordinate of the human key point representing the skeletal joint as the ankle.

7. The method according to claim 2, wherein the determining of the target proportional relationship according to the human height and the control height, comprises:
based on that a ratio of the control height to the human height is greater than a preset threshold, determining the target proportional relationship as a first template;
based on that the ratio of the control height to the human height is less than or equal to the preset threshold, determining the target proportional relationship as a second template; wherein both the first template and the second template comprise a corresponding ratio of the first actual length to the second actual length of the other body part except the target body part, and the corresponding ratio in the first template is different from the corresponding ratio in the second template.

8. The method according to claim 1, further comprising:
based on a selection operation on a target function, displaying a target interface;
wherein the target interface comprises a playback control for playing the target video and a preview control for displaying the virtual digital human.

9. The method according to claim 1, further comprising:
performing style transfer on a target face image collected by the image acquisition device when playing the target video to obtain a transferred image corresponding to the target face image;
performing key point detection on the transferred image to obtain face key points of the transferred image;
determining driving key points and driving anchor points of the transferred image according to the face key points and corner points of the transferred image;
obtaining texture coordinates of the transferred image according to coordinates of the driving key points and coordinates of the driving anchor points;
performing triangular meshing on the driving key points and the driving anchor points to obtain a plurality of texture triangles of the transferred image; and
driving the transferred image according to a vertex coordinate sequence corresponding to a real-time obtained driving voice, the texture coordinates, and the plurality of texture triangles to generate a style transfer animation corresponding to the target face image.

10. The method according to claim 9, wherein the face key points of the transferred image comprise 68 key points;
wherein the method further comprises:
selecting 20 driving key points from mouth key points, left eye key points and right eye key points among the face key points;
setting 8 driving anchor points according to the mouth key points, chin key points, nose key points, the left eye key points and the right eye key points among the face key points; and
setting 4 driving anchor points according to the corner points of the transferred image.

11. An apparatus for generating a virtual digital human, comprising:
a display, configured to display an image and/or user interface; and
at least one processor, configured to execute instructions to cause the apparatus to:
obtain a first frame image collected by the image acquisition device when playing a target video; wherein the target video comprises at least one fitness action;
perform human key recognition on the first frame image, to determine position information between human key points, a first actual length of a target body part, and a second actual length of other body part except the target body part;
determine a predicted length of the other body part except the target body part according to a target proportional relationship and the first actual length; wherein the target proportional relationship comprises a corresponding ratio of the first actual length to the predicted length of the other body part except the target body part;
determine a drawing height of the other body part based on the second actual length and the predicted length; and
generate the virtual digital human by drawing based on the first actual length, the drawing height, and the position information.

12. The apparatus according to claim 11, wherein the at least one processor is further configured to execute instructions to cause the apparatus to:
obtain a second frame image collected by the image acquisition device when starting to play the target video; wherein the second frame image comprises a human body facing the image acquisition device and performing a target action;
perform human key recognition on the second frame image to determine at least one human key point and configuration information of each of the at least one human key point; wherein the configuration information comprises the position information and a confidence level;
based on that both the position information and the confidence level meet a standing condition, obtain a control height of a preview control; wherein the preview control is configured to display the virtual digital human;
determine a human height according to first information and second information; wherein the first information comprises position information of the human key point representing a skeletal joint as a nasal, and the second information comprises position information of the human key point representing a skeletal joint as an ankle; and
determine the target proportional relationship according to the human height and the control height.

13. The apparatus according to claim 12, wherein the at least one processor is further configured to execute instructions to cause the apparatus to:
perform human key recognition on the second frame image by using a human key point detection algorithm to determine the at least one human key point and the configuration information of each of the at least one human key point.

14. The apparatus according to claim 12, wherein the at least one processor is further configured to execute instructions to cause the apparatus to:
based on that the confidence level is greater than or equal to a confidence threshold, the position information meets a first condition, and an angle formed by three target key points is greater than or equal to an angle threshold, obtain the control height of the preview control; wherein the target key point is any one of the at least one human key point.

15. The apparatus according to claim 14, wherein the position information comprises at least ordinates, and the target body part comprises a torso;
wherein the first condition comprises:
a sum of an ordinate of the human key point representing the skeletal joint as the nasal and an obtained value is less than an ordinate of the human key point representing the skeletal joint as a left hip, an ordinate of the human key point representing the skeletal joint as a left knee is greater than or equal to an ordinate of the human key point representing the skeletal joint as the left hip, and an ordinate of the human key point representing the skeletal joint as a right knee is greater than or equal to an ordinate of the human key point representing the skeletal joint as a right hip;
or,
the sum of the ordinate of the human key point representing the skeletal joint as the nasal and the obtained value is less than the ordinate of the human key point representing the skeletal joint as the right hip, the ordinate of the human key point representing the skeletal joint as the left knee is greater than or equal to the ordinate of the human key point representing the skeletal joint as the left hip, and the ordinate of the human key point representing the skeletal joint as the right knee is greater than or equal to the ordinate of the human key point representing the skeletal joint as the right hip;
wherein the obtained value is determined according to a length of the torso.

16. The apparatus according to claim 12, wherein the position information comprises at least ordinates;
wherein the at least one processor is further configured to execute instructions to cause the apparatus to:
determine the human height according to an absolute value of a difference between an ordinate of the human key point representing the skeletal joint as the nasal and an ordinate of the human key point representing the skeletal joint as the ankle.

17. The apparatus according to claim 12, wherein the at least one processor is further configured to execute instructions to cause the apparatus to:
based on that a ratio of the control height to the human height is greater than a preset threshold, determine the target proportional relationship as a first template;
based on that the ratio of the control height to the human height is less than or equal to the preset threshold, determine the target proportional relationship as a second template; wherein both the first template and the second template comprise a corresponding ratio of the first actual length to the second actual length of the other body part except the target body part, and the corresponding ratio in the first template is different from the corresponding ratio in the second template.

18. The apparatus according to claim 11, wherein the at least one processor is further configured to execute instructions to cause the apparatus to:
based on a selection operation on a target function, display a target interface;
wherein the target interface comprises a playback control for playing the target video and a preview control for displaying the virtual digital human.

19. The apparatus according to claim 1, wherein the at least one processor is further configured to execute instructions to cause the apparatus to:
perform style transfer on a target face image collected by the image acquisition device when playing the target video to obtain a transferred image corresponding to the target face image;
perform key point detection on the transferred image to obtain face key points of the transferred image;
determine driving key points and driving anchor points of the transferred image according to the face key points and corner points of the transferred image;
obtain texture coordinates of the transferred image according to coordinates of the driving key points and coordinates of the driving anchor points;
perform triangular meshing on the driving key points and the driving anchor points to obtain a plurality of texture triangles of the transferred image; and
drive the transferred image according to a vertex coordinate sequence corresponding to a real-time obtained driving voice, the texture coordinates, and the plurality of texture triangles to generate a style transfer animation corresponding to the target face image.

20. The apparatus according to claim 19, wherein the face key points of the transferred image comprise 68 key points;
wherein the at least one processor is further configured to execute instructions to cause the apparatus to:
select 20 driving key points from mouth key points, left eye key points and right eye key points among the face key points;
set 8 driving anchor points according to the mouth key points, chin key points, nose key points, the left eye key points and the right eye key points among the face key points; and
set 4 driving anchor points according to the corner points of the transferred image.
